(19) United States
(12) Patent Application Publication
(10) Pub. No.: US 2026/0344929 A1
(43) Pub. Date: Nov. 5, 2026

(54) Non-Flourinated Hybrid Paek/Silicone Resin Coating

(71) Applicant: SEB S.A., Ecully (FR)

(72) Inventors: Barbara Gantillon, Ecully Cedex (FR); Stéphanie Le Bris, Ecully Cedex (FR); Perrine Tanguy, Ecully Cedex (FR)

(73) Assignee: SEB S.A., Ecully (FR)

(21) Appl. No.: 18/998,881

(22) PCT Filed: Jul. 28, 2023
(86) PCT No.: PCT/FR2023/051199

§ 371 Date: Jan. 27, 2025

(30) Foreign Application Priority Data
Jul. 29, 2022 (FR) FR2207865

(51) Int. Cl. A47J 36/02; A47J 27/00; A47J 36/04; C09D 7/61; C09D 183/06; C23C 4/04

(52) U.S. Cl. CPC A47J 36/025; A47J 27/002; A47J 27/004; A47J 36/04; C09D 7/61; C09D 183/06; C23C 4/04

(57) ABSTRACT

A coated cooking element for a kitchen utensil or electrical cooking appliance includes a metal substrate coated, on at least one face, with at least the following layers in said order starting from the metal substrate: a porous hard sublayer having one or more polyetherarylketones (PEAK) and mixtures thereof, optionally fillers, optionally less than 3% by weight of additives relative to the weight of the hard sublayer, and optionally less than 3% by weight of coloring agent(s) relative to the weight of the hard sublayer, optionally, one or more intermediate layers having one or more coloring agents and optionally—one or more silicone resins, and/or—one or more thermoplastic polymers and/or, —one or more fillers, and/or—one or more additives, a finishing layer having one or more silicone resins and optionally—one or more thermoplastic polymers, and/or—one or more fillers, and/or—one or more additives, and/or—flakes.

### CROSS-REFERENCE TO RELATED APPLICATIONS

The present application is a national phase entry under 35 U.S.C. § 371 of International Application No. PCT/FR2023/051199 filed Jul. 28, 2023, which claims priority from French Application No. 2207865 filed Jul. 29, 2022, all of which are incorporated herein by reference. The field of the invention is that of culinary items coated on one of their faces with a coating and more precisely, the silicone resin-based coatings of these items.

In the field of culinary items, fluoropolymer-based coatings and in particular polytetrafluoroethylene (PTFE) are known to the general public for their non-stick and temperature resistance properties.

However, these coatings have a low mechanical strength.

Application WO 2020144051 relates to a fluoropolymer-based coating, for which the mechanical resistance to abrasion is improved by incorporation of organic (SiC) and mineral (Al₂O₃) fillers in the primary and finishing layers of the coating.

The improvement in performance achieved with regard to mechanical strength is satisfactory, but still not optimal.

The fluoropolymer-based coatings are primarily intended for pots and pans, but other applications are possible in the field of the moulding (moulds, cake dishes, waffle makers, etc.) or small domestic equipment (rice cookers, fryer vessels, electric crepe makers) due to their stampability.

An alternative to PTFE coatings consists of using so-called “ceramic” coatings, developed by the sol-gel method and the use of tetraethyl orthosilicate (EP 2 806 776 B1). These coatings have the particular properties of being hard and resistant to mechanical wear, but also exhibiting brittle behaviour and lower non-stick properties compared to fluoropolymer-based coatings.

In addition, these coatings are not very suitable for moulding and for small domestic equipment due to their lack of stampability.

In the field of moulding (by the general public or industrial moulding), fluoropolymer-based coatings are not as widespread, because the temperature resistance constraints are lower (maximum 220 °C) and allow the use of other types of coatings, such as silicone coatings.

Pure silicone resins are described as non-stick and resistant to temperatures greater than 220-230 °C. By contrast, they are considered to adhere poorly to the substrate.

On the other hand, silicone polyester resins are very widely used in moulding because they are non-stick while adhering to the substrate and being compatible with the stamping processes. However, they degrade at temperatures greater than 230 °C. More specifically, culinary items are used in the temperature range between 50 and 250 °C and it is not surprising to reach temperatures of 300 °C or even 350 °C in the case of items with induction bottoms. Their use is therefore not compatible with the temperatures of use in the field of culinary items.

The present invention addresses the technical problem of improving the scratch resistance and chip resistance of silicone coatings, through the production of a sublayer in contact with the metal substrate, based on mixtures of thermoplastic and/or thermostable polymers with high thermomechanical properties.

In order to significantly improve the scratch resistance of silicone coatings, the inventors have shown that it was possible to produce a macroporous sublayer with a formulation suitable for thermofusible resin sprayed by thermal spraying on a metal substrate without preheating to more than 100 °C, then directly applying the one or more layers of liquid silicone coatings by conventional pneumatic spraying. The presence of reinforcement fillers (alumina, silicon carbide etc.) is also possible in the sublayer.

The production of this “composite” with a strong anchoring of the silicone in the matrix of the polymer sublayer, produces a final coating with greatly improved mechanical properties.

This coating has excellent adherence performance due to good cohesion between the first PEEK-based layer and the layers of the coating.

This invention makes it possible to produce a high-thickness overall layer without causing cracking and crazing.

It has an excellent scratch resistance and resistance to mechanical impacts.

This invention makes it possible to obtain excellent anti-scratch performance, while maintaining a method with a single final curing, which makes it industrially economic.

The scratch resistance and impact resistance being broadly increased, the use of metal utensils does not lead to major damage.

The consumer will therefore possess a more durable item, with a coating more effectively preventing direct contact of the food with the substrate (increased durability of non-stick performance, increased safety in the case of contact with aluminium, improved aesthetics, etc.).

The method, without preheating or drying at high temperature, and with only one final curing at a temperature less than 400 °C, is inexpensive and robust.

The coating, which is more robust when faced with mechanical stresses, will therefore also have an increased durability in terms of non-stick, non-stain and corrosion resistance properties.

Patent EP 2 319 631 describes the development of a two-layer silicone resin-based coating coupled with a high-temperature thermoplastic material between 0.5 and 20% (base layer) making it possible to obtain a coating that is mechanically strong, adherent to the substrate and non-stick. The nature of the thermoplastic varies between the base layer (PEEK) and the finishing layer (PPS) and this is mainly located in the base layer in order to ensure adherence to the substrate. This patent does not describe a temperature indicator.

Application US 2022/0073785 proposes two-layer silicone/thermoplastic coating architecture which is much more concentrated in thermoplastic material and also does not describe the incorporation of a colour indicator based on thermochromic pigments.

### SUMMARY OF THE INVENTION

The first object of the invention relates to a coated cooking element (1) for a culinary item or electrical cooking appliance, comprising a metal substrate (2) coated on at least one face (2a) by at least the following layers, in this order starting from the metal substrate (2):
(3a) a porous hard sublayer consisting of one or more polyetherarylketones (PEAK) and the mixtures thereof, optionally fillers, optionally less than 3% by weight of additives relative to the weight of said hard sublayer and optionally less than 3% by weight of colouring agent(s) relative to the weight of said hard sublayer,
(3b) optionally one or more intermediate layers consisting of one or more colouring agents and optionally
   one or more silicone resins, and/or
   one or more thermoplastic polymers and/or,
   one or more fillers, and/or
   one or more additives
(3c) a finishing layer consisting of one or more silicone resins and optionally
   one or more thermoplastic polymers, and/or
   one or more fillers, and/or
   one or more additives, and/or
   flakes.

Another object of the invention relates to a method for manufacturing a coated cooking element (1) according to the invention comprising the following successive steps:
a) a step of supplying a metal support (2), comprising two opposite faces;
b) optionally, a step of treating the face (2a) of the support (2), in order to obtain a treated face (2a) promoting the adherence of a hard sublayer (3a) on the support (2);
c) a step of producing an adherent hard sublayer (3a) on said internal face (2a) by thermal spraying, onto said internal face (2a) of a powder or dispersion of one or more polyetherarylketones (PEAK) and the mixtures thereof, optionally fillers, optionally less than 3% by weight of additives and optionally less than 3% by weight of colouring agent(s) relative to the weight of said hard sublayer (3a);
d) optionally drying and/or curing
e) optionally applying the one or more layers (3ab) and/or one or more intermediate layers (3b);
f) applying the finishing layer (3c);
g) drying and/or curing.

Another object of the invention relates to a culinary item (100) comprising a coated cooking element (1) according to the invention.

Another object of the invention relates to an electric cooking appliance (200) comprising a coated cooking element (1) according to the invention and a heating source (210) designed to heat said coated cooking element (1).

### DEFINITIONS

The term “layer” should be understood, in the context of the present invention, as a continuous or discontinuous layer. A continuous layer (also called a monolithic layer) is a single whole forming a total flat surface completely covering the surface on which it is applied.

The term “discontinuous” shall mean a layer which is not of uniform thickness over the entire surface on which it is deposited. The coverage may be non-existent in certain places.

The term “base layer”, “primer layer”, “bonding layer” or “bonding primer” shall mean all the layers from the first layer applied directly on the support (it is preferable that this layer adheres well to the support and contributes all its mechanical properties to the coating: hardness, scratch resistance) to the last layer before the first decoration layer.

The term “finishing layer” or “finish” shall mean a continuous transparent surface layer, this layer allowing perfect visibility of the decoration layer while protecting it from mechanical attacks and giving the coating non-stick properties.

Preferably, the last finishing layer is intended to be in contact with the food.

The term “decoration” or “decoration layer” shall mean one or more continuous or discontinuous layers comprising a pigmentary composition. The decoration can be in the form of one or more patterns, with one or more colours. A decoration is clearly visible to the user with the naked eye and at a conventional distance of use of the household item.

The term “overlapping layers” shall mean partially or completely superposed layers. These layers can be in the form of partially overlapping patterns, for example concentric discs.

The term “adjacent layers” shall mean non-superimposed layers. These layers can be in the form of non-superimposed, identical or different patterns, preferably uniformly distributed.

The term “reference temperature pigmentary composition” shall mean a composition comprising a pigment which, at a given temperature, can indicate to the user that the optimum temperature of use has been reached. This indication is made by comparing the colours of the thermochromic pigmentary composition and of the reference temperature pigmentary composition. Either the optimum temperature of use is reached when the colours are identical, or the optimum temperature of use is reached when the colours are visually very different.

The “reference temperature pigmentary composition” can comprise a pigment which has:
the same colour as the thermochromic pigmentary composition, at the optimum temperature of use,
   either because at ambient temperature this pigment has the same colour as the thermochromic pigmentary composition at the optimum temperature of use, and does not change colour with temperature,
   or because at ambient temperature this pigment has a different colour from that of the thermochromic pigmentary composition which changes to the same colour as the thermochromic pigmentary composition at the optimum temperature of use,
a very different colour of that of the thermochromic pigmentary composition at the optimum temperature of use, whether or not this pigment changes colour or not with the change in temperature.

The optimum temperature of use can be reached when the colour of the reference temperature pigmentary composition corresponds to a colour indicated in the user guide of the household item comprising the coating of the invention or to a colour indicated on a colour scale supplied to the user with said item.

The reference temperature pigmentary composition is thermochromic or thermostable.

The reference temperature pigmentary composition can be, for example, a reference cooking temperature pigmentary composition or be for indicating a risk of overheating.

The present invention has at least the following advantages:
the coating according to the invention has a thermochromic functionality with a marked visibility, a colour change contrasted over a targeted range of temperatures and centred, for example, around food cooking temperatures for a kitchen appliance;
the coating according to the invention can provide a good temperature control when cooking food, which is necessary for health and taste reasons, but also for safety and to limit occasional overheating which weakens the coating;
the thermochromic pigmentary composition has reversible thermochromic properties, i.e. after a colour change under the action of heat the compound returns to its initial state and to its initial colour, when the temperature reduces; this colour change cycle (reversibility) can be infinitely repeated;
the coating according to the invention has a significant thermal stability when the temperature rises; it is stable up to approximately 450 °C.

The expression “thermochromic semiconductor” shall mean that it must comprise, within the meaning of the present invention, a mineral or organic compound which has a reversible change of colour following an increase in temperature. The gradual and reversible thermochromic nature of these semiconductor compounds is linked to the reduction in the width of the band gap of the semiconductor due to the expansion of the material. More specifically, the periodicity of the lattice of anions and cations leads to the gathering of the energy levels into energy bands. The higher-energy filled energy band is called the valence band and the lower-energy empty energy band is called the conduction band. Between these two bands, there is a forbidden band called the band gap. The colour of a semiconductor material can come from the presence of a charge transfer which corresponds to the passage of an electron either from the valence band to a conduction band on a given atom, or commonly from the orbit of an anion to the orbit of a cation (inter-atomic photon absorption).

In the fields of application intended for the present invention, the optimum conditions are attained when the coating reaches a temperature suitable for the cooking of food, preferably between 100 and 250 °C.

In the context of the present invention, the term “thermochromic pigment or pigmentary composition” should be understood to mean a pigment or a pigmentary composition which changes colour as a function of temperature in a given temperature range, this change being reversible. This colour change is visible to the user with the naked eye and at a conventional distance of use.

The term “thermostable pigment” shall mean a pigment which does not exhibit a colour change when it is subjected to an increase in temperature in a given temperature range, or which exhibits a change in hue when it is subject to an increase in temperature in a given temperature range which is so small that it is not visible to the user with the naked eye and at a conventional distance of use.

Thermostable pigments preferably have a colour deviation ΔE* between 25 °C and 200 °C less than 10, ΔE* being defined by the CIE1976 formula in the CIELAB colour space:

ΔE*=\sqrt{(L₂*−L₁*)²+(a₂*−a₁*)²+(b₂*−b₁*)²}
L₁*, a₁* and b₁* characterising the L*a*b* values of said compound at ambient temperature, L₂*, a₂* and b₂* characterising the L*a*b* values of said compound at 200 °C.

The expression “the colours are identical” shall mean that they are indistinguishable by the user with the naked eye and at a conventional distance of use.

The expression “culinary item” shall be understood, in the context of the present invention, as an item intended for cooking. For this purpose, it is intended to receive a heat treatment.

The expression “item intended to receive a heat treatment” should be understood, in the context of the present invention, as an item which will be heated by an external heating system, such as frying pans, saucepans, sauté pans, woks and barbecue grills, and which is capable of transferring heat provided by this external heating system to a material or food in contact with said item.

The expression “electrical cooking appliance” should be understood, in the context of the present invention, as a heating object having its own heating system such as an electric crepe maker, electric raclette appliance, electric fondue appliance, electric grill, electric plancha grill, electric cooker, bread-making machine or electric pressure-cooking appliance.

The term “coating” shall mean all of the layers adhering to the metal substrate and covering this substrate. The coating obtained according to the invention is advantageously solid. The term “solid” refers to the property of a cohesive material that is insoluble in water, in normal solvents, in the food components such as aqueous or fatty mixtures, even if the material may have a high hardness or high flexibility like an elastomer.

The term “silicone resin-based coating” shall mean a coating which comprises one or more silicone resins in one or more of its layers.

The term “equivalent diameter of the pores” shall mean the diameter of the sphere having the same volume as the pore in question.

The term “mean equivalent diameter of the pores” shall mean the mean of the equivalent diameters of the pores.

The term “median equivalent diameter of the pores” shall mean the median of the equivalent diameters of the pores: 50% of the pores have an equivalent diameter less than this diameter and 50% have a higher equivalent diameter.

In the present invention, the % by weight are expressed by dry weight, i.e. without solvent.

### FIGURES

FIG. 1: diagram of a cooking element according to the invention, for which layer (3b) is continuous and covers the entirety of the layer (3a)

FIG. 2: diagram of a cooking element according to the invention, for which the layer (3b) does not cover the entirety of the layer (3a) and forms a decoration

FIG. 3: diagram of a cooking element according to the invention, for which the layer (3b) consists of two decorations (i) and (j)

FIG. 4: pattern distribution diagram. 4A=non-overlapping adjacent patterns. 4B=partially overlapping patterns. 4C=overlapping patterns.

FIG. 5: SEM-EDXS analysis, Example 1

FIG. 6: SEM-EDXS analysis, Example 2

FIG. 7: Analysis by X-ray microtomography of Example 2

FIG. 8: diagram of culinary item according to the invention

FIG. 9: diagram of electrical cooking appliance according to the invention

### DETAILED DESCRIPTION OF THE INVENTION

The invention relates to a coated cooking element (1) for a culinary item or electrical cooking appliance, comprising a metal substrate (2) coated on at least one face (2a) by at least the following layers, in this order starting from the metal substrate (2):
(3a) a porous hard sublayer consisting of one or more polyetherarylketones (PEAK) and the mixtures thereof, optionally fillers, optionally less than 3% by weight of additives relative to the weight of said hard sublayer and optionally less than 3% by weight of colouring agent(s) relative to the weight of said hard sublayer,
(3b) optionally one or more, preferably two, intermediate layers consisting of one or more colouring agents, and optionally
   one or more silicone resins, and/or
   one or more thermoplastic polymers and/or,
   one or more fillers, and/or
   one or more additives
(3c) a finishing layer consisting of one or more silicone resins and optionally
   one or more thermoplastic polymers, and/or
   one or more fillers, and/or
   one or more additives, and/or
   flakes.

Advantageously, the layers (3a) and optionally (3b) and (3c) form a coating (3) which coats the metal substrate (2). This coating (3) has non-stick properties and forms a non-stick coating.

Advantageously, the layer (3a) is in contact via one of its faces with the metal substrate (2) via its face (2a).

The at least one coated face (2a) of the metal substrate is therefore a cooking face. In other words, the coating of the cooking element (1) according to the invention is intended to be in contact with food.

The coating of the cooking element (1) according to the invention does not comprise a fluorinated polymer, also called a fluoropolymer. In other words, said coating is or is devoid of fluorinated polymer.

The coating of the cooking element (1) according to the invention does not comprise any fluorinated polymer.

The coating of the cooking element (1) according to the invention is intended to be in contact with the food.

Advantageously, the finishing layer (3c) is in contact via one of its faces with food and thus forms a cooking face (5).

Advantageously, the one or more polyaryletherketones (PAEK) are selected from the group consisting of: polyetherketones (PEK), polyetheretherketone (PEEK), polyetherketoneketones (PEKK), polyetheretherketoneketones (PEEKK) and polyetherketoneetherketoneketones (PEKEKK), particularly preferably are PEEK and mixtures thereof.

Preferably, the mean thickness of the hard sublayer (3a) is greater than 5 μm, more preferably greater than 15 μm, particularly preferably between 20 and 50 μm. This mean is, for example, the mean of at least 10 measurements, preferably 15 measurements, of thickness in 10, respectively 15, random locations.

Advantageously, the mean equivalent diameter of the pores in the hard sublayer (3a) is greater than 5 μm.

The porosity data of the hard sublayer (3a), in particular the overall porosity fraction, the mean equivalent diameter of the pores and the median equivalent diameter of the pores are measured by X-ray microtomography using a synchrotron source.

Preferably, the mean equivalent diameter of the pores of the hard sublayer (3a) is greater than 8 μm, more preferably greater than 10 μm.

Preferably, the median equivalent diameter of the pores of the hard sublayer (3a) is greater than 6 μm, more preferably greater than 7 μm, yet more preferably greater than 8 μm.

Preferably, more than 30%, more preferably more than 40%, particularly preferably more than 50% of the pores by number in the hard sublayer (3a) have a mean equivalent diameter <10 μm.

Preferably, more than 20%, more preferably more than 30%, of the pores by number in the hard sublayer (3a) have a mean equivalent diameter >10 μm and 20 μm.

Preferably, more than 60%, more preferably more than 70%, particularly preferably more than 80% of the pores by number in the hard sublayer (3a) have a mean equivalent diameter 20 μm.

Preferably, more than 5%, more preferably more than 7%, particularly preferably more than 10% of the pores by number in the hard sublayer (3a) have a mean equivalent diameter >20 μm and <30 μm.

Preferably, of the pores by number in the hard sublayer (3a) have an equivalent diameter of the pores greater than 30 μm, preferably at least 1% of the pores by number in the hard sublayer (3a) have an equivalent diameter of the pores greater than 30 μm.

Preferably, the hard sublayer (3a) has a surface roughness Ra of between 5 m and 100 m, more preferably between 10 μm and 60 μm.

Preferably, the hard sublayer (3a) has a developed surface area Sdr of between 10% and 100%, preferably between 30% and 80%.

Advantageously, the thickness of the layer (3c) is between 0.05 μm and 100 μm, preferably between 0.08 μm and 20 μm, particularly preferably between 0.1 μm and 10 μm. In a particular embodiment of the invention, the thickness of the layer (3c) is 100 nm+/−5 nm.

According to an embodiment, the thickness of the layer (3c) is between 0.1 μm and 2 microns, preferably between 0.2 μm and 1.5 μm.

According to another embodiment, the thickness of the layer (3c) is between 10 μm and 100 μm, preferably between 20 μm and 85 μm, particularly preferably between 30 μm and 70 μm.

The coating of the cooking element (1) according to the invention may comprise one or more optional layers (3ab), inserted between the one or more layers (3a) and the one or more layers (3b) or between the one or more layers (3a) and the one or more layers (3c) consisting of one or more silicone resins and optionally
one or more thermoplastic polymers, and/or
one or more fillers, and/or
one or more additives,

Advantageously, the thickness of the one or more layers (3ab), when present, is between 0.05 μm and 100 μm, preferably between 0.08 μm and 20 μm, particularly preferably between 0.1 μm and 10 μm.

Advantageously, the thickness of the layer (3b) is between 1 μm and 100 μm, preferably between 2 μm and 30 μm, particularly preferably between 3 μm and 10 μm.

### Metal Substrate

Advantageously, said metal substrate (2), also referred to as support, is a substrate made of aluminium, stainless steel, cast iron or aluminium, iron, titanium or copper.

Within the meaning of the present invention, aluminium shall be understood to be a metal composed of 100% aluminium or an aluminium alloy.

Advantageously, the metal substrate (2) is a substrate made of aluminium, stainless steel or a multilayer metal substrate. The metal substrate (2) can be a two-layer or three-layer substrate, these multiple layers being able to be obtained, for example, by co-lamination, by hot diffusion under load (solid state bonding) or by hot or cold impact bonding.

Preferably, the metal substrate (2) comprises alternating layers of metal and/or metallic alloy.

According to an embodiment, the metal substrate (2) is a substrate made of an aluminium or stainless-steel alloy, or a multilayer metal substrate for which the face (2a) is an aluminium or stainless-steel alloy.

Preferably, the metal substrate (2) is an aluminium substrate.

Advantageously, the thickness of the metal substrate (2) is between 0.5 mm and 10 mm.

Advantageously, the face (2a) of the metal substrate (2) has undergone a prior surface treatment for improving the adhesion of the coating to said substrate.

According to an embodiment, the surface of the face (2a) of the metal substrate (2) has undergone a surface treatment, said surface treatment being a chemical etching, brushing, hydration, sandblasting, shot peening, physicochemical plasma, corona or laser treatment, chemical activation or a combination of these different techniques.

Advantageously, the face (2a) of the substrate on which the coating (3) according to the invention will be applied can be treated so as to increase its specific surface area; for an aluminium substrate, this treatment can be made by anodisation (creation of a tubular alumina structure), by chemical etching, sandblasting, brushing, shot peening or by addition of material using a technology such as thermal spraying (flame, plasma or arc spraying). Other metal substrates can also be polished, sandblasted, brushed, microbead blasted or receive an addition of material using a technology such as thermal spraying (flame, plasma or arc spraying).

Metals usable as substrates in the present invention advantageously include substrates made of aluminium that may or may not be anodised, optionally polished, brushed, sandblasted, shot peened or microbead blasted, substrates made of aluminium alloy which may or may not be anodised, optionally polished, brushed, sandblasted or microbead blasted, substrates made of steel which is optionally polished, brushed, sandblasted, shot peened or microbead blasted, substrates made of stainless steel which is optionally polished, brushed, sandblasted or microbead blasted, substrates made of cast steel, aluminium or iron, and substrates made of copper that is optionally hammered or polished.

Advantageously, the substrate can be selected from substrates comprising ferritic stainless steel/aluminium/austenitic stainless-steel layers, substrates comprising stainless steel/aluminium/copper/aluminium/austenitic stainless-steel layers, cast aluminium, aluminium or aluminium alloy calottes lined with an external base of stainless steel, metallic co-laminated substrates, for example two-layer co-laminated substrates comprising a stainless-steel layer (for example intended to constitute the internal face of the item) and a layer of aluminium or aluminium alloy, anodised or not (for example intended to constitute the external face of the item).

Advantageously, the arithmetic mean roughness Ra of the surface of the face (2a) of the metal substrate (2) is greater than or equal to 1 μm.

The arithmetic mean roughness Ra is measured by means of a roughness meter according to standard ISO 4287. Ra represents the arithmetic mean of the deviations from the mean. The surface topography can be studied, in particular, using a profile meter with probe equipped with a fine stylus having a diamond tip, or with an Altisurf®-type optical metrology instrument in which a confocal chromatic sensor enables a contact free measurement. The study of this surface topography data makes it possible to define the arithmetic mean roughness Ra.

### Silicone Resins

In the text of the description, the expression “silicone resin” is used interchangeably to refer to silicone before or after its crosslinking. In the text of the description, the expression “silicone” designates an organopolysiloxane material. Crosslinking is the step which makes it possible to transform silicone into an insoluble material, for example by polyaddition, polycondensation or dehydrogenation. The crosslinking is performed on precursors which are generally oils or silicone resins, which crosslink in order to obtain a three-dimensional network forming a material called a silicone resin in the description.

This crosslinking can be carried out by thermal activation or chemical activation using a catalyst, such as platinum for example.

The silicone resins can be obtained from precursors that are advantageously soluble in a solvent or in the water of an emulsion, such as crosslinkable oils or resins, in particular selected from: a silicone hydride, a silicone oil resin comprising at least one vinyl group (—CH═CH₂), a silicone resin or silicone-polyester resin (copolymer) comprising at least one alkoxy group, for example a methoxy or ethoxy group, and/or a silicone resin or silicone-polyester resin (copolymer) comprising at least one alkoxy group, in particular an ethoxy group, or a hydroxy group and the mixtures thereof. These precursors have the ability to crosslink in order to obtain a silicone resin which is characterised by its insolubility and its substantially solid form.

Advantageously, these precursors are polymers or oligomers, either in the form of silicone oils with variable degree of branching, or in the form of silicone resins with variable degrees of pre-crosslinking or silicone resin copolymers such as silicone-polyester, silicone-alkyd, silicone-polyurethane or silicone-epoxy resins, or in the form of a mixture of silicone oils, silicone resins and silicone resin copolymers. The silicon atoms can be substituted by alkyl (in particular methyl) or aryl (in particular phenyl) groups or the mixtures thereof. The oils or resins preferably comprise one or more (2, 3 or more) hydroxy or alkoxy (in particular methoxy, ethoxy, butoxy) functional groups as substituents for silicon atoms.

Advantageously, the one or more silicone resins, obtained after crosslinking of their precursors, i.e. crosslinked, are selected from the group consisting of methyl silicone and/or phenyl silicone and/or methyl-phenyl-silicone resins, methyl silicone-polyester resin (copolymers), phenyl silicone-polyester resin (copolymers), methyl-phenyl silicone-polyester resin (copolymers), silicone resin-alkyd resin (copolymers), modified silicone resin and the mixtures thereof.

Advantageously, the one or more silicone resins are selected from the group consisting of methyl silicone and/or phenyl silicone and/or methyl-phenyl-silicone resins, methyl silicone-polyester resin (copolymers), phenyl silicone-polyester resin (copolymers), methyl-phenyl silicone-polyester resin (copolymers), silicone-alkyd resin (copolymers), modified silicone resin and the mixtures thereof.

The silicone resins can be obtained from precursor chosen, in particular, from: silicone hydride, a silicone resin comprising at least one vinyl group (—CH═CH₂), a silicone-polyester resin (copolymer) comprising at least one methoxy group, and/or a silicone-polyester resin (copolymer) comprising at least one ethoxy group, and the mixtures thereof.

The silicone resin of the single layer (3) forms a network which can consist of a combination of 4 single organosiloxane units denoted M, D, T and Q depending on the degree of substitution by oxygen of the silicon atom, as described in the following table, where R is an organic substituent described below.

| | Degree of substitution by | |
|---|---|---|
| Structure | oxygen | Symbol |
| R₃Si—O— | 1 | M |
| 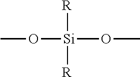 | 2 | D |
| 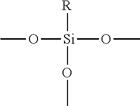 | 3 | T |
| 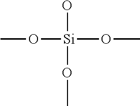 | 4 | Q |

The organopolysiloxane material or polymer is obtained by crosslinking from precursors which may be monomers or polymers, or in an intermediate manner which may be oligomers. The organopolysiloxane polymer can also be obtained from a mixture of these different sorts of precursors. When the network contains a higher number of T and Q units than D units, the crosslinking density is higher. The distribution between the M, D, T and Q units depends on the chemical structure of the precursors, in particular on this M, D, T, Q distribution within the precursors.

The polymer precursors are organopolysiloxanes. These macromolecules are formed of M, D, T, and/or Q units as described in the table, where R is independently an alkyl group, in particular methyl, or aryl, in particular phenyl, different types of R being able to be present on the same macromolecule.

The organopolysiloxanes can be either linear or slightly branched (mostly D groups), or branched or very branched (mostly T and Q groups). The linear or slightly branched organopolysiloxanes are generally liquids, more or less viscous at ambient temperature, and are called silicone oils. The branched or very branched (pre-crosslinked) organopolysiloxanes form a network on the individual macromolecule scale and are called silicone resins. At ambient temperature, the resins are substantially in solid form, or in liquid form provided that, in particular, they have a fairly low molecular mass, in the form of a solution in a solvent or in aqueous emulsion form. They can be copolymerised with organic polymers or oligomers not comprising silicon, selected in particular from polyesters, acrylics, alkyds, the polyurethane and epoxy resins.

When the crosslinking is a hydrolysis-polycondensation: it is carried out using the hydroxy or alkoxy reactive functions, in particular methoxy, ethoxy or butoxy, present on the organopolysiloxane.

When the crosslinking is a polyaddition (or hydrosilylation): it is carried out by reaction between the reactive vinyl functions (—CH═CH₂) present on one of the organopolysiloxanes and the reactive silyl-hydride functions (Si—H) present on the other organopolysiloxane mixed with the first.

All these reactive functions are present on each organopolysiloxane, being at least one in number, and can be present with 2, 3 or more in number, as much as the molecular structure allows. Silicone oils comprising at least one reactive function are called “reactive oils”. The reactive functions can be either at the end of a macromolecular chain (termination), or distributed over the chain.

Silicone-polyester resins have, in particular, silicone/polyester mass ratios of for example 90/10, 80/20, 70/30, 60/40, 50/50, 40/50, 30/70, 20/80, 10/90, advantageously between 80/20 and 50/50.

Linear PDMS silicone oils, pure or pre-emulsified in water, are primarily characterised by their molecular mass, which is a directly increasing function of the viscosity of the pure oil. They are then characterised by the presence or otherwise of reactive functions, for example hydroxyls on the silicon atoms (silanol), their number and their location on the molecular chain. For example, reactive oils with viscosities between 50 and 20,000 mPa·s, and, in particular, between 300 and 5000 mPa·s, can be used, having at least one reactive function, preferably at least 2, which can be located at the end of the chain.

The polymer precursors reacting by polyaddition may include, for example, polymethylhydrosiloxane, vinylmethylsiloxane, vinyl-terminated, in particular linear, polydimethylsiloxane (PDMS), vinyl-terminated diphenylsiloxane-dimethylsiloxane copolymers, hydride-terminated polydimethylsiloxanes, hydride-terminated polyphenylmethylsiloxanes, cyclic vinylmethylsiloxane, vinyl-MQ resin, trimethylsilyl-terminated polymethylhydrosiloxane, trimethylsiloxane-terminated copolymer of methylhydrosiloxane and dimethylsiloxane, MQ resin hydride, and the like, as well as the combinations thereof.

The polymer precursors reacting by hydrolysis-polycondensation, whether they are silicone resins or silicone oils, can include, for example, poly(methylsilsesquioxanes), poly(propylsilsesquioxanes), poly(phenylsilsesquioxanes), polydimethylsiloxane (PDMS), trimethylsiyl-terminated polydimethylsiloxane (PDMS), hydroxyl-terminated polydimethylsiloxane (PDMS), silanol-terminated polydimethylsiloxane (PDMS), silanol-terminated polyphenylsiloxane (PDMS), the silanol-terminated copolymer of diphenylsiloxane-dimethylsiloxane, poly(2-acetoxyethylsilsesquioxanes), organo-modified alkoxy-silanes and their oligomers, and all similar macromolecules as well as the mixtures thereof.

The organopolysiloxane material or polymer can also be obtained by crosslinking of a mixture of one or more monomer precursors and one or more polymer precursors as described above, as well as one or more oligomer precursors which may be linear, branched or cyclic. These oligomer precursors have a lower molecular mass than the polymer precursors. Polymer and/or oligomer precursors comprising a number of reactive functions as described above, greater than 2, advantageously much greater than 2, can be added to the mixture as “co-binder” in order to promote a high crosslinking density of the organopolysiloxane polymer finally obtained.

The monomer, oligomer and/or polymer precursors, in particular silicone resins, copolymerised or not with an organic polymer, play the role of polymer binder with a view to obtaining solid organopolysiloxane polymer combined with the thermoplastics of each layer.

The silicone oil type organopolysiloxane precursors can be considered as additives if they are added in small quantity (in general between 0.1 and 5% dry) in the overall formulation of a layer, independently of other components for the formation of the solid organopolysiloxane polymer.

The crosslinking may require a catalyst:
in the case of crosslinking of organopolysiloxanes by hydrolysis-polycondensation, the formula can include a metal catalyst, such as metal complexes based on platinum, tin, zinc, zirconium and cerium, in particular the complexes platinum-cyclovinylmethyl-siloxane, tin ethylhexanoate, zinc ethylhexanoate, zirconium ethylhexanoate, cerium ethylhexanoate and the tin dibutyl laurate.
in the case of the crosslinking of organopolysiloxanes by hydrosylilation, the addition of a catalyst may be necessary; this can be, for example, platinum or a suitable platinum-based catalyst such as the Karstedt catalyst or Ashbys catalyst.

A crosslinking agent bearing, for example, Si—H bonds may be present.

According to an embodiment, the proportion of silicone resin in the layer (3b) is greater than or equal to 20% by weight relative to the total weight respectively of the layer (3b).

According to another embodiment, the proportion of silicone resin in the layer (3b) is greater than or equal to 40% by weight relative to the total weight respectively of the layer (3b).

According to yet another embodiment, the proportion of silicone resin in the layer (3b) is greater than or equal to 50% by weight relative to the total weight respectively of the layer (3b).

According to an embodiment, the proportion of silicone resin in the layer (3c) is greater than or equal to 20% by weight relative to the total weight respectively of the layer (3c).

According to another embodiment, the proportion of silicone resin in the layer (3c) is greater than or equal to 30% by weight relative to the total weight respectively of the layer (3c).

According to yet another embodiment, the proportion of silicone resin in the layer (3c) is greater than or equal to 40% by weight relative to the total weight respectively of the layer (3c).

According to yet another embodiment, the proportion of silicone resin in the layer (3c) is greater than or equal to 50% by weight relative to the total weight respectively of the layer (3c).

According to yet another embodiment, the proportion of silicone resin in the layer (3c) is greater than or equal to 60% by weight relative to the total weight respectively of the layer (3c).

According to an embodiment, the proportion of silicone resin in the one or more layers (3ab) is greater than or equal to 20% by weight relative to the total weight respectively of the layer (3ab). According to another embodiment, the proportion of silicone resin in the one or more layers (3ab) is greater than or equal to 40% by weight relative to the total weight respectively of the layer (3ab). According to yet another embodiment, the proportion of silicone resin in the one or more layers (3ab) is greater than or equal to 50% by weight relative to the total weight respectively of the layer (3ab).

### Thermoplastic Polymers

Advantageously, the one or more thermoplastic polymers are selected from the group consisting of polyethersulfone (PES), polyphenylene ether sulfone (PPSU), polyamideimide (PAI), polyimide (PI), poly(phenylene oxide) (PPO), poly(arylene sulfide) (PAS), polyetherimide (PEI), polybenzymidazole (PBI), liquid crystal polymers (LCP), polyphenylene sulfide (PPS), polyarylether ketone (PAEK) including polyether ketone (PEK), polyether ether ketone (PEEK), polyether ketone ketone (PEKK), polyether ether ketone ketone (PEEKK), polyether ketone ether ketone ketone (PEKEKK) and the mixtures thereof.

Heterocyclic thermoplastic polymers Heterocyclic thermoplastic polymers include by way of example, according to the invention, polyetherimides (PEI), polyimides (PI), polyamideimides (PAI) and polybenzymidazole (PBI), or the mixtures thereof.

### PAEK

Advantageously, the one or more polyaryletherketones (PAEK) are selected from the group consisting of: polyetherketones (PEK), polyetheretherketone (PEEK), polyetherketoneketones (PEKK), polyetheretherketoneketones (PEEKK) and polyetherketoneetherketoneketones (PEKEKK), particularly preferably are PEEK.

Advantageously, the nature of the one or more thermoplastic polymers in the layers (3b) and (3c) can be identical or different.

Advantageously, the layer (3b) comprises one or more thermoplastic polymers, preferably in a proportion by weight of said layer less than 30%, preferably less than 20%.

Advantageously, the layer (3c) comprises one or more thermoplastic polymers, preferably in a proportion by weight of said layer less than 50%, preferably less than 40%.

Advantageously, the one or more layers (3ab) comprise one or more thermoplastic polymers, preferably in a proportion by weight of said layer less than 50%, preferably less than 40%.

According to an embodiment, the layer (3b) and the layer (3c) comprise one or more thermoplastic polymers, the proportion of thermoplastic polymers in the layer (3c) being preferably greater than the proportion of thermoplastic polymers in the layer (3b).

According to another embodiment, the layer (3b) and the layer (3c) comprise one or more thermoplastic polymers, the proportion of thermoplastic polymers in the layer (3b) being greater than the proportion of thermoplastic polymers in the layer (3c).

### Fillers

The fillers according to the invention provide mechanical reinforcement and can also provide hydrophobicity properties, while improving the mechanical strength and the thermal conductivity of the coating.

The fillers are not only there to provide colour to the coating, but can also contribute to it.

The presence of fillers with excellent thermal conductivity can compensate for the low thermal conductivity of PAEK polymers.

Advantageously, the one or more fillers are selected from the group consisting of ceramic (SiO₂, etc.) and/or mineral and/or metal (Al₂O₃, TiO₂, etc.) and/or silica and/or diamond particle fillers.

Preferably, the one or more fillers are selected from the group consisting of metal oxides, metal carbides, metal oxynitrides, metal nitrides and the mixtures thereof.

Advantageously, said metal is a transition metal, such as at least one of the elements selected from B, Ni, Ti, Zr or Hf.

Yet more preferably, the one or more fillers are selected from the group consisting of:
fillers for reinforcement: hard organic or inorganic fillers; the hard inorganic fillers are preferably particles of silicon carbide or alumina or zirconia, or graphite, or ceramics, or carbonate, or hydrated alumina, aluminium hydroxide or one or more metal oxides, graphite, graphene;
other fillers for the reinforcement selected from metal oxides: silica, micas, laminar fillers, clays such as montmorillonite, sepiolite, gypsite, kaolinite and laponite, zinc dioxide, quartz and zirconium phosphate, alumina, zirconia, zinc oxide, copper oxide and iron oxide;
fillers selected from the reinforcement fibres: glass, carbon or aramid fibre;
conductive fillers comprising a transition metal carbide and/or a transition metal nitride: characterised in that the transition metal is at least one of the elements selected from B, Ni, Ti, Zr or Hf, for example: cubic boron nitride, diamond particles, metal particles;
lamellar fillers, such as clays, graphene or graphite, can provide lubricating properties.

The preferred fillers in combination with organopolysiloxanes are:
reinforcing fillers: silica or carbonates with filler contents of at least 10-15 wt. % and up to 60 wt. %,
alumina, hydrated alumina, aluminium hydroxide,
silica (precipitated or pyrogenic) with a d50<0.1 μm and a specific surface area BET >30 m2/g and preferably between 30 and 500 m2/g,
or mixture of quartz and silica, diatomaceous earth or ground quartz, titanium, mica, talc, kaolin, barium sulfate, slaked lime, zinc oxide, expanded vermiculite, unexpanded vermiculite, calcium carbonate etc.

Yet more preferably, the one or more fillers are selected from the group consisting of alumina, silicon carbide, tungsten carbide, boron nitride, quartz, and the mixtures thereof.

Advantageously, the fillers present in the sublayer (3a) are hard inorganic fillers, preferably particles of silicon carbides or alumina or zirconia or graphite, or carbon black, or ceramics, or of one or more metal oxides.

Certain hard inorganic fillers, such as silicon carbide, in addition to their mechanical reinforcement performance, also have the advantage of being conductive fillers and thus provide excellent thermal conductivity.

The addition of this type of filler can improve the culinary result with better heat diffusion from the metal substrate to the foods in contact with the coating.

Advantageously, the median diameter d50 of the fillers is between 0.1 and 50 μm, more advantageously between 5 and 15 μm.

Advantageously, the proportion of fillers in a layer is between 0.5 and 30% by dry weight relative to the total weight of said layer after curing, preferably between 5 and 20%.

Advantageously, the proportion of fillers in the layer (3a) is greater than 20% by weight, preferably greater than 30% by weight, relative to the total weight of said layer.

Advantageously, the proportion of fillers in the layer (3c) is less than 10% by weight relative to the total weight of said layer.

Advantageously, the proportion of fillers in the layers (3a), (3ab), (3b) and (3c) can be identical or different.

Advantageously, the nature of the fillers in layers (3a), (3ab), (3b) and (3c) can be identical or different.

### Additives

Advantageously, said additives are selected from the group consisting of anti-foaming agents, dispersants, wetting agents, thickeners, pH regulators, reactive silicone oils.

Said one or more anti-foaming agents are preferably selected from the group consisting of mineral oils, diols, hydrocarbons, glycerides, oxyrane and emulsified fatty acids.

The one or more surfactants are preferably selected from the group consisting of glycol ether, ethoxylated alcohol with the exclusion of alkyl phenol ethoxylates (APE), gemini surfactants.

The one or more dispersants are preferably selected from the group consisting of anionic dispersants such as fatty acid derivatives.

Said thickeners are preferably selected from the group consisting of acrylic-based or polyurethane-based copolymer, cellulose and pyrogenic silica.

Said pH regulators are preferably selected from the group consisting of Bronsted bases: ammonia, amines (triethyl amine, triethanolamine . . . ), (sodium, potassium, etc.) hydroxides, carbonates.

Advantageously, the proportion of additives in the layer (3a) is less than 1% by weight relative to the total weight of said layer.

Advantageously, the proportion of additives in the layer (3c) is less than 20% by weight relative to the total weight of said layer.

Advantageously, the proportion of additives in the one or more layers (3ab) is less than 20% by weight relative to the total weight of said layer.

### Colouring Agents

Advantageously, the one or more colouring agents are selected from the group consisting of thermochromic pigments, thermostable pigments, flakes, preferably holographic flakes, and the mixtures thereof.

Advantageously, the proportion of colouring agents in the layer (3b) and the layer (3c) is between 0.5 and 50% by dry weight relative to the total weight of said layer after curing.

Advantageously, the proportion of colouring agents in the layer (3b) ranges from 10% to 40% by weight relative to the total weight of said layer.

Advantageously, the proportion of colouring agents in the layer (3c), when present, is less than 10% by weight relative to the total weight of said layer.

Advantageously, the proportion of colouring agents in the layers (3b) and (3c) can be identical or different.

Advantageously, the nature of the colouring agents in the layers (3b) and (3c) can be identical or different.

### Thermochromic Pigments

Preferably, the one or more thermochromic pigments are selected from the group consisting of Bi₂O₃, Fe₂O₃, V₂O₅, WO₃, CeO₂, In₂O₃, Y_{1.84}Ca_{0.16}Ti_{1.84}V_{0.16}O_{10.84}, AgI, (Bi₁₋ₓAₓ)(V_{1-y}M_{y})O₄ with:
x is equal to 0 or x is between 0.001 and 0.999,
y is equal to 0 or y is between 0.001 and 0.999,
A and M are chosen from the group consisting of nitrogen, phosphorus, an alkali metal, an alkaline earth metal, a transition metal, a poor metal, a metalloid or a lanthanide,
A and M are different from each other.

Knowing that A and M are different from each other, when:
A is an alkali metal, it can be selected from Li, Na, K, Rb, Cs,
M is an alkali metal, it can be selected from Li, Na, K, Rb, Cs,
A is an alkaline earth metal, it can be selected from Be, Mg, Ca, Sr, Ba,
M is an alkaline earth metal, it can be selected from Be, Mg, Ca, Sr, Ba,
A is a transition metal, it can be selected from Sc, Ti Cr, Mn, Fe, Co, Ni, Cu, Y, Zr, Nb, Mo, Ru, Rh, Pd, Ag, Ta, W, Ir,
M is a transition metal, it can be selected from Sc, Ti Cr, Mn, Fe, Co, Ni, Cu, Y, Zr, Nb, Mo, Ru, Rh, Pd, Ag, Ta, W, Ir,
A is a poor metal, it can be selected from Al, Zn, Ga, In, Sn,
M is a poor metal, it can be selected from Al, Zn, Ga, In, Sn,
A is a metalloid, it can be selected from B, Si, Ge, Sb,
M is a metalloid, it can be selected from B, Si, Ge, Sb,
A is a lanthanide, it can be selected from La, Ce, Pr, Nd, Pm, Sm, Eu, Gd, Tb, Dy, Ho, Er, Tm, Yb, Lu,
M is a lanthanide, it can be selected from La, Ce, Pr, Nd, Pm, Sm, Eu, Gd, Tb, Dy, Ho, Er, Tm, Yb, Lu.

Preferably, A and M, different from each other, are B and/or Mg.

Preferably, the pigment (Bi₁₋ₓAₓ)(V_{1-y}M_{y})O₄ has a monoclinic scheelite crystalline form at ambient temperature.

Preferably, x and y are 0, i.e. the pigment (Bi₁₋ₓAₓ)(V_{1-y}M_{y})O₄ is bismuth vanadate (BiVO₄). Advantageously, BiVO₄ is used, which has a monoclinic scheelite structure at ambient temperature.

Bismuth vanadate is a yellow-coloured inorganic compound, of formula BiVO₄, widely used for its colouring properties and for its lack of toxicity. It is entered in the Colour Index International as Q. I. Pigment Yellow 184, it is marketed, in particular by Heubach (Vanadur®), BASF (Sicopal®), FERRO (Lysopac) or again Bruchsaler Farbenfabrik (Brufasol®).

### Thermostable Pigments

Preferably, the one or more thermostable pigments are selected from the group consisting of:
titanium rutile yellow pigments,
yellow pigments derived from bismuth, for example selected from the stabilised bismuth vanadates (Py₁₈₄)
red pigments, for example selected from perylene red (for example PR149, PR178 and PR224), iron oxide,
bismuth oxyhalide orange pigments (PO₈₅),
bismuth vanadate orange pigments (PO₈₆)
tin titanium zinc orange pigment (PO₈₂)
cerium sulfide orange pigment (PO₇₅; PO₇₈)
chromium antimony titanium rutile orange-yellow pigment (PBr₂₄)
zinc tin rutile orange-yellow pigment (Py₂₁₆)
zinc tin sulfide niobium oxide orange-yellow pigment (Py₂₂₇)
niobium tin double oxide orange-yellow pigment
Co₃(PO₄)₂
LiCoPO₄
CoAl₂O₄
Cr₂O₃
TiO₂
black pigment PBk28 (Copper chromite black spinel)
and the mixtures thereof.

### Decorations

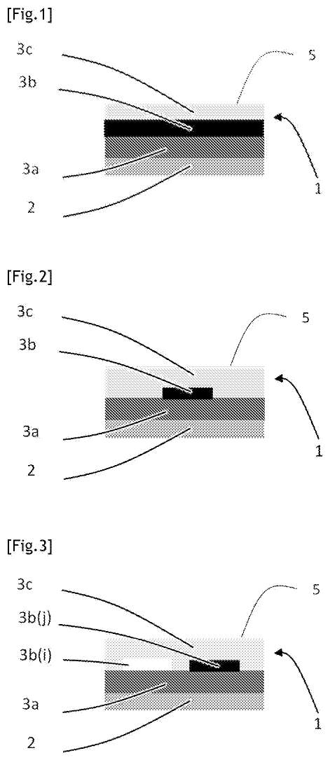

According to an embodiment, the one or more layers (3b) are continuous and cover the entirety of the layer (3a) (see FIG. 1).

According to another embodiment, the one or more layers (3b) do not cover the entirety of the layer (3a) and form at least one decoration (see FIG. 2).

Advantageously, the one or more layers (3b) form a plurality of decorations, one (i) comprising one or more thermochromic pigments and the other (j) comprising at least one reference temperature pigmentary composition (see FIG. 3).

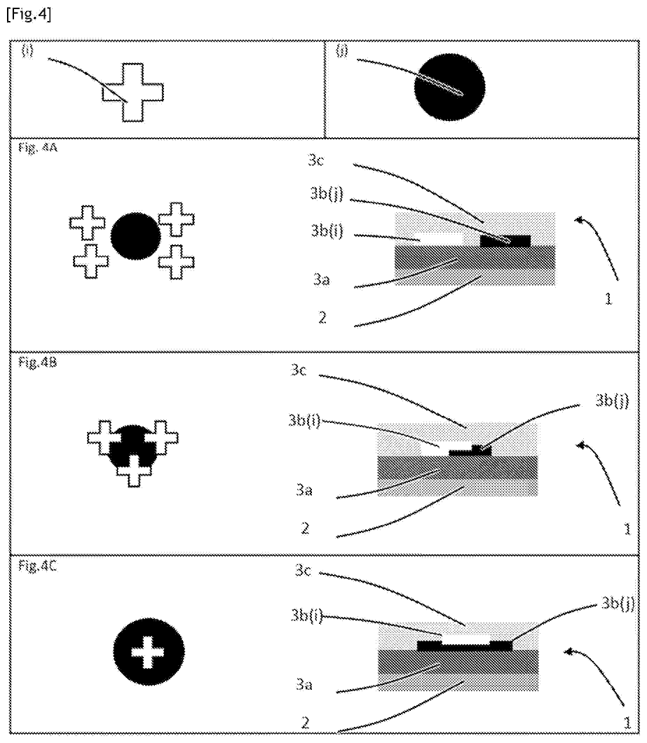

According to an embodiment, each of the two decorations (i) and (j) is in the form of non-overlapping adjacent patterns. For example, each decoration is represented by different geometric patterns uniformly distributed over the entire surface and alternating with respect to one another (see FIG. 4A).

According to another embodiment, the two decorations (i) and (j) are partially overlapping. For example, each decoration is represented by different geometric patterns uniformly distributed over the entire surface and partially overlapping (see FIG. 4B).

Preferably, the two decorations (i) and (j) are overlapping, either because one of the two decorations is a continuous layer and the other decoration covers it in the form of patterns, or because the two decorations (i) and (j) are in the form of overlapping patterns (see FIG. 4C).

### Flakes

The flakes which can be used in the context of the present invention can be independently selected from coated or uncoated mica flakes, coated or uncoated silica flakes, coated or uncoated aluminium flakes and coated or uncoated iron oxide flakes. Mica or silica flakes coated with titanium dioxide. The flakes that can be used in the context of the present invention can be treated in order to give a particular colour effect.

Advantageously, the one or more flakes are particles chosen from the group consisting of particles of mica, aluminium, mica coated with titanium dioxide, or the mixtures thereof.

### Holographic Flakes

Advantageously, the one or more flakes are holographic flakes, i.e. a mixture of magnetisable particles and non-magnetisable particles.

The magnetisable particles can advantageously be particles comprising at least one ferromagnetic metal. These magnetisable particles can be homogeneous, i.e. formed of the same material, or composite, i.e. these magnetisable particles have a core-shell structure, in which the ferromagnetic metal is located in the core and/or in the shell of said particles. Examples of composite magnetisable particles include, in particular, mica flakes coated with iron oxide Fe2O3 or stainless-steel fibres coated with a sol-gel material, as protection against corrosion during the steps of implementing the coating, or else flakes made of plastic material and coated with iron oxide Fe2O3, or flakes for which the core is made of ferromagnetic metal and the shell is formed of a plastic material or of a sol-gel material.

According to an embodiment, some of said magnetisable particles are oriented so as to form a three-dimensional decoration.

Advantageously, the mixture of magnetisable particles and non-magnetisable particles represents between 1% and 5% by weight of the weight of the layer, preferably between 2% and 3% by weight.

Advantageously, the percentage of non-magnetisable particles in the mixture of magnetisable particles and non-magnetisable particles is between 15% and 40% by weight relative to the total weight of the mixture of magnetisable particles and non-magnetisable particles.

Advantageously, the magnetisable particles have a size D50 less than equal to 23 μm.

In the context of the present invention, the term “D50” shall mean the maximum size exhibited by 50% of the particles by number.

Advantageously, the non-magnetisable particles have a size D90 between 20% and 250% of the size D90 of the magnetisable particles.

In the context of the present invention, the term “D90” shall mean the maximum size exhibited by 90% of the particles by number.

Advantageously, the magnetisable particles and/or the non-magnetisable particles are coloured at the surface.

Advantageously, the non-magnetisable particles are formed of mica, aluminium or mica coated with titanium dioxide.

Advantageously, the magnetisable particles are formed of iron, iron oxide, aluminium coated with iron, or mica coated with iron, the iron being in ferritic form.

### Preferred Architectures

Advantageously, the invention relates to a coated cooking element (1) for a culinary item or electrical cooking appliance, comprising a metal substrate (2) coated on at least one face (2a) by at least the following layers, in this order starting from the metal substrate (2):
(3a) a porous hard sublayer consisting of one or more polyetherarylketones (PEAK) and the mixtures thereof, optionally fillers, optionally less than 3% by weight of additives relative to the weight of said hard sublayer and optionally less than 3% by weight of colouring agent(s) relative to the weight of said hard sublayer,
(3b) optionally, one or more decorations comprising one or more colouring agents
(3c) a finishing layer consisting of one or more silicone resins and optionally
   one or more thermoplastic polymers, and/or
   one or more fillers, and/or
   one or more additives.

Typically, the mean thickness of the hard sublayer (3a) is between 20 and 50 μm. This mean is, for example, the mean of at least 10 measurements, preferably 15 measurements, of thickness in 10, respectively 15, random locations.

Preferably, the colouring agent of the one or more intermediate layers (3b) comprises pigments and/or flakes, advantageously holographic flakes.

According to an alternative, the one or more intermediate layers (3b) consist of:
one or more colouring agents, in particular pigments and/or flakes, advantageously holographic flakes,
one or more thermoplastic polymers advantageously selected from polyamideimide (PAI), polyimide (PI), polyetherimide (PEI), polybenzymidazole (PBI), polyethersulfone (PES), polyphenylene ether sulfone (PPSU), polyarylether ketone (PAEK), and the mixtures thereof,
0 to 10% fillers,
0 to 20% additives,
optionally one or more silicone resins.

According to another alternative, the one or more intermediate layers (3b) consist of:
one or more colouring agents, in particular pigments and/or flakes, advantageously holographic flakes,
0 to 10% fillers,
0 to 20% additives,
one or more silicone resins, and
optionally, one or more thermoplastic polymers advantageously selected from polyamideimide (PAI), polyimide (PI), polyetherimide (PEI), polybenzymidazole (PBI), polyethersulfone (PES), polyphenylene ether sulfone (PPSU), polyarylether ketone (PAEK), and the mixtures thereof,

According to a particular alternative, the one or more intermediate layers (3b) do not comprise silicone resin.

According to another particular alternative, the one or more intermediate layers (3b) consist of:
one or more colouring agents, in particular pigments and/or flakes, advantageously holographic flakes,
one or more thermoplastic polymers advantageously selected from polyamideimide (PAI), polyimide (PI), polyetherimide (PEI), polybenzymidazole (PBI), polyethersulfone (PES), polyphenylene ether sulfone (PPSU), polyarylether ketone (PAEK), and the mixtures thereof,
0 to 10% fillers,
0 to 20% additives,
one or more silicone resins.

According to a particular embodiment, the coating comprises two intermediate layers (3b), of which at least one is a decoration layer. Advantageously, the one or more layers (3b) form a plurality of decorations, one (i) comprising one or more thermochromic pigments and the other (j) comprising at least one reference temperature pigmentary composition.

Advantageously, the thickness of the layer (3b) is between 1 μm and 100 μm, preferably between 2 μm and 30 μm, particularly preferably between 3 μm and 10 μm.

Preferably, the one or more intermediate layers (3b) only cover part of the base layer (3a).

Alternatively, according to another embodiment, the coating has no intermediate layer (3b).

According to an embodiment, the finishing layer (3c) consists of one or more silicone resins and optionally one or more thermoplastic polymers.

According to another embodiment, the finishing layer (3c) consists of one or more silicone resins and one or more thermoplastic polymers.

Advantageously, the thickness of the layer (3c) is between 0.05 μm and 100 μm, preferably between 0.08 μm and 20 μm, particularly preferably between 0.1 μm and 10 μm.

In a particular embodiment, the mean thickness of the hard sublayer (3a) is between 20 and 50 μm, the thickness of the layer (3b) is between 3 μm and 10 μm, and the thickness of the layer (3c) is between 0.1 μm and 10 μm. The mean thickness of the hard sublayer (3a) is, for example, the mean of at least 10 measurements, preferably 15 measurements, of the thickness at 10, respectively 15, random locations.

### Method

The method also relates to a method for manufacturing a coated cooking element (1) according to the invention, comprising the following successive steps:
a) a step of supplying a metal support (2), comprising two opposite faces;
b) optionally, a step of treating the face (2a) of the support (2), in order to obtain a treated face (2a) promoting the adherence of a hard sublayer (3a) on the support (2);
c) a step of producing an adherent hard sublayer (3a) on said internal face (2a) by thermal spraying, onto said internal face (2a) of a powder or dispersion of one or more polyetherarylketones (PEAK) and the mixtures thereof, optionally fillers, optionally less than 3% by weight of additives and optionally less than 3% by weight of colouring agent(s) relative to the weight of said hard sublayer (3a);
d) optionally drying and/or curing
e) optionally applying the one or more layers (3ab) and/or one or more intermediate layers (3b);
f) applying the finishing layer (3c);
g) drying and/or curing.

Advantageously, the steps of the method according to the invention make it possible to coat the metal support (2) with a coating (3) formed by the layers (3a), optionally (3ab) and (3b), and (3c).

In general, the layers (3ab), (3b) and (3c) are wet at the time of application. In the context of the present invention, “wet layer” shall mean that the layer comprises all or part of its solvents.

Preferably, all or part of the solvents of the wet layer are removed, either naturally or by a physical treatment, for example thermal drying, drying by an air flow or by vacuum treatment.

Advantageously, the coating composition according to the invention can further comprise at least one solvent. Advantageously, the solvent can be a protic solvent. Advantageously, the solvent can be non-toxic

The solvent that can be used in the coating composition according to the invention, can advantageously comprise at least one alcohol, and can preferably be selected from isopropanol, methanol, ethanol and the mixtures thereof.

The application of the coating is made in several layers. In this case, the deposition on at least one of the two opposite faces of said support of at least one layer of the coating (3) according to the invention, is repeated several times. Preferably, a drying step is carried out between the application of each layer, then the curing of said coated support is carried out after application of the last layer. The application of the coating (3) by the method according to the invention on the support (2) makes it possible to obtain a layer of thermostable coating.

The coating formula to be coated is generally in aqueous form, the polymers of the polymer phase being in the form of suspensions. Other non-aqueous solvents may also be suitable.

Advantageously, the method for manufacturing a coated cooking element (1) according to the invention comprises one or more drying steps between 80 and 150 °C after application of each of the layers. The drying can be carried out by convection or infra-red.

The application of the coating according to the invention by the method according to the invention can be made on the shaped support or even on a locally flat zone of the shaped support. A layer of thermostable coating is obtained.

Advantageously, the method for manufacturing a coated cooking element (1) according to the invention comprises a step of shaping said metal support (2) before step c. The shaping is also called stamping.

When the shaping step precedes the application iii of the coating, the coating is preferably carried out by spraying.

When this shaping step is subsequent to the application vii. of the coating, the coating is preferentially produced by screen printing or by roller.

The method according to the invention comprises a step g. of curing/drying the element obtained in step f. of the method. In the context of the present invention, “curing the coated substrate, shall mean a thermal treatment which enables the one or more coating layers applied on the substrate to be densified, but also to crosslink the organopolysiloxane (silicone resin) precursors.

In step g., the curing is performed. In general, the curing temperature of step g. is from 230 °C to 420 °C.

Advantageously, the method for manufacturing a coated cooking element (1) according to the invention comprises a single final curing step g. of all the applied layers. This single curing step is carried out simultaneously for all the applied layers.

The thermal spraying, as its name indicates, consists of spraying a powder or a dispersion onto the surface.

Preferably, in step a), the metal support (2) is in the form of a disc.

Advantageously, the method according to the invention comprises no other curing step than that of step g).

Preferably, the thermal spraying is a spraying with a flame (“flame spray”) or a cold gas dynamic spray (“cold spray”).

In flame spray, the spraying of powder fractions associated with the at least partial melting of the non-fluoridated polymer material explains the discontinuity of the hard sublayer (3a).

Preferably, the material intended to be sprayed is a powdered material with a particle size distribution D50 by volume from 5 m to 60 m, and preferably from 10 to 35 μm.

Preferably, in flame spray, step c) of producing the hard sublayer (3a) is preceded by a step of preheating said support (2) at low temperature. This preheating is carried out at a maximum temperature of 100 °C.

Preferably, in cold spray, the step c) of producing the hard sublayer (3a) is preceded by a step of preheating said support (2) to between 150 and 300 °C.

Preferably, the curing step (g) is carried out in a furnace at a temperature of 230 °C to 420 °C.

The application step (f) and step (e) of applying the one or more layers (3ab) can be carried out by electrostatic powder coating, solvent-phase or aqueous-phase spraying, screen printing, roller or digital printing.

Step (e) of applying the one or more intermediate layers (3b) can be carried out by pad printing, screen printing, inkjet of flexography.

### Item

The invention also relates to a culinary item (100) comprising a coated cooking element (1).

According to an embodiment, the culinary item (100) comprises a heating face (6) intended to be placed in contact with an external heating source, the heating face (6) being opposite the cooking face (5) intended to be placed in contact with the food during cooking.

Advantageously, the culinary item (100) according to the invention is chosen from the group consisting of a saucepan, frying pan, pans or pots for fondue or raclette, stew pot, wok, sauté pan, crepe maker, grill, plancha grill, cooking pot, casserole, vessel for a cooker or bread-making machine, culinary mould.

The invention also relates to an electric cooking appliance (200) comprising a coated cooking element (1) according to the invention and a heating source (210) designed to heat said coated cooking element (1).

Advantageously, the electric cooking appliance (200) is chosen from the group consisting of an electric crepe maker, electric raclette appliance, electric fondue appliance, electric grill, electric plancha grill, electric cooker, bread-making machine, electric pressure-cooking appliances, waffle makers, rice cookers and jam makers.

The culinary item according to the present invention can, in particular, be a culinary item for which one of the two opposite faces of the substrate is an internal, optionally concave, face intended to be arranged on the side of food likely to be introduced into or onto said item, and for which the other face of the substrate is an, optionally convex, outer face intended to be arranged facing a heat source.

By way of non-limiting examples, culinary items according to the present invention include, in particular, culinary items such as pots and pans, woks and the sauté pans, stew pots and casseroles, crepe makers, baking pans and trays, barbecue plates and grills, and preparation bowls.

### EXAMPLES AND RESULTS

The goals, aspects and advantages of the present invention will be better understood on reading the following description of a particular embodiment of the invention presented by way of non-limiting example.

Of course, the invention is in no way limited to the embodiment described and illustrated, which is only given by way of example. Modifications remain possible, in particular in terms of the constitution of the various elements or by substitution of technical equivalents, without going beyond the scope of protection of the invention.

### Raw Materials:

The raw materials for layer (3a) are detailed below.

The raw materials for the intermediate layers (3b and 3b′) and the finishing layer (3c) are as follows:
Silicone resins:
   RS1: Ethoxy functionalised silicone-polyester resin (80% silicone/20% polyester) in solvent phase, viscosity at 25 °C approx. 2000 mPas, solids content=75%
   RS2: ethoxy functionalised silicone-polyester resin (50% silicone/50% polyester) in solvent phase, viscosity at 25 °C approx. 2000 mPas, solids content=75%
   RS3: ethoxy functionalised silicone-polyester resin (30% silicone/70% polyester) in solvent phase, viscosity at 25 °C approx. 2000 mPas, solids content=75%
   RS4: methyl phenyl functionalised silicone-polyester resin in solvent phase, viscosity at 25 °C approx. 2000 mPas, solids content=75%
   RS5: methoxy functionalised silicone-polyester resin (50% silicone/50% polyester) in solvent phase, viscosity at 25 °C approx. 2000 mPas, solids content=75%
   RS6: ethoxy functionalised methyl organopolysiloxane resin in aqueous emulsion, viscosity at 25 °C approx. 1500 mPas, solids content=52%
Heterocyclic polymer resins:
   polyamide-imide resin (PAI) at 29% dry extract in N-butylpyrrolidone (NBP), Torlon from SOLVAY
Other aromatic polymer resins:
   powdered polyetheretherketone (PEEK), Vicote 703 from VICTREX, powdered polymer with a d50 of 25 μm,
   powdered polyetheretherketone (PEEK), Vicote 704 from VICTREX, powdered polymer with a d50 of 10 μm,
   powdered PEKK resin, KEPSTAN 7002 PT from Arkema with a d50 of 20 μm,
   powdered PEKK resin, KEPSTAN 6002 PT from Arkema with a d50 of 50 μm,
   powdered polyethersulfone (PES) resin, micronised grade from SOLVAY, polymer powder with a d50 of 40 μm.
Alcohol solvent
   dipropylene glycol butyl ether (DPNB),
   2-methoxy-1-methylethyl acetate (MPA),
   butyl glycol acetate (BGA),
   butyl acetate,
surfactant and anti-foaming agent
   Mineral oil: Tego foamex K7 from Evonik
   Fatty alcohol polyglycol ether: Genapol X080 from Clariant or Tergitole TMN-100X,
Reinforcing fillers:
   Pyrogenic silica: Levasil CC301,
   Fumed silica after-treated with dimethyl dichlorosilane: Aerosil R972
Pigments:
   Mica: IRIODIN 100 or IRIODIN 300 and/or Magnapearl 5000,
   Cr/Fe oxide: Sicopal black K0098FK,
   Carbon black: Derussol F25 or Cabot Monarch 4750,
   Perylene red Paliogen red (PR178)
   Iron III oxide: H856 brick
Acrylic resin:
   Rohagit SD 15: acrylic polymer solution with 30% in aqueous phase
Silicone oil:
   Polyether modified polysiloxane: TEGO GLIDE 100,
   Polydimethylsiloxane oil: CT 601M
Other additives:
   AMP 90: solution of 2-amino-2-methyl-1-propanol: polymer with 90% in aqueous phase, buffer agent,
   Metolat 368: fatty acid ester,
   Dolfynox 1030: propoxylated polyglycol ether, wetting agent,
   Edaplan LA 451: anionic ester in ethanol/water, wetting agent
   Tego Glide 407: methyl phenyl polysiloxane, flow agent.

### Operating Principle of the Jar Mill (Mechanical Grinder)

Ball milling involves loading a jar with the sample to be ground and the so-called grinding balls, and rotating the jar around its axis at a certain speed. The rotation of the jar is generally achieved using a roller machine. This sample can be ground in dry form or dispersed in an appropriate solvent (for example in water or in alcohol). The dispersion can also contain certain adjuvants (such as a dispersant or an anti-foaming agent).

The median diameter of the grinding balls must be adapted to the size of the particles to be ground. The finer the particles, the smaller the diameter of the balls to be used. The total volume of balls, including the spaces between the balls, will represent approximately 50-60% of the internal volume of the jar. Balls of different sizes are advantageously distributed according to the following weighted proportion relative to the total weight of the balls: 25% small balls, 50% medium balls and 25% large balls. The smallest dimension of the balls is between 2 and 10 mm. Stabilised alumina and zirconia are commonly used as the material of the balls.

### Tests

### Test of Resistance to Mechanical Impact (Ball Impact):

Impact resistance of the non-stick coating evaluated by means of the Erichsen test in accordance with standard ISO 6272.

This involves an impact test by dropping a 2-kg ball, the height of the drop being 50 cm. Aluminium or stainless-steel plates are used for the test, as appropriate, one of the phases of which is coated with a two-layer coating according to present invention. The plates are all identical with one another (in terms of thickness and the nature of the alloy) in order to have constant deformation for all the tests.

This test comprises producing an impact directly on the coating, deposited on the coated face of a plate (internal stamping test), and an impact on the face opposite to that coated with the coating of another plate (external stamping test).

After carrying out the impacts, a visual examination of the coated face of the coating is performed.

The impact resistance of the coating is estimated according to the following visual scale, which is established, on the one hand, after a direct impact on the coating (internal stamping test) and, on the other hand, on the face opposite that coated with the coating (external stamping test).
The score of 0 is attributed if the following is observed:
for the internal stamping test:
at the point of the impact, a complete delamination of the coating over the entire deformed surface of the internal face which is manifest by the appearance of a “white” area at the point of impact (corresponding to a portion of metal surface without coating), in the form of a disc having a diameter of order 25 mm.

For the external stamping test:
also a complete delamination of the coating over a large area of the deformed internal face, which is manifest by the appearance of a “white” area at the point of impact (corresponding to a portion of metal surface without coating), this area being in the form of a disc having a diameter of at least 10 mm.
The score of 1 is attributed if the following is observed:
for the internal stamping test:
at the point of the impact, an almost complete delamination of the coating over a large area of the deformed internal face, this delamination being manifest by the appearance of an almost “white” area at the point of impact (corresponding to a portion of metal surface without coating), this area being in the form of a disc having a diameter of order 20 mm.

For the external stamping test:
an almost complete delamination of the coating over a medium area of the deformed internal face, which is manifest by the appearance of a “white” area without coating, at the point of impact, being in the form of a disc having a diameter of order 10 mm.
The score of 2 is attributed if the following is observed:
for the internal stamping test: at the point of impact, an almost complete delamination of the coating over a medium area of the coated internal face, which is manifest by the appearance of a “white” area without coating, at the point of impact, being in the form of a disc having a diameter of order 10 mm.

For the external stamping test:
at the point of impact, a white area in the form of a disc of diameter less than 10 mm, in which large chips are located, extending to the metal surface of the support, with a relatively high chip density.
The score of 3 is attributed if it is observed that:
for the internal stamping test:
at the point of impact, a central area in which large chips are located allowing appearance of the metal.

For the external stamping test:
at the point of impact, a white surface in the form of a disc of diameter less than 10 mm, in which fine chips are located, extending to the metal with a moderately high density.
The score of 4 is attributed if the following is observed:
for the internal stamping test:
at the point of impact, an area in the form of a small-diameter disk, in which fine chips are located, extending to the metal with a rather low density.

For the external stamping test, some pits going down to the metal, which are located at the point of impact.

Finally, the score of 5 is attributed if the following is observed:
for the internal stamping test:
at the point of impact, a slight halo is seen, a little lighter than the coating.

For the external stamping test:
no changes in the appearance of the coating.

The higher the score obtained, the better the impact resistance of the coating.

### SEM/EDXS Characterisations:

An SEM is a versatile multifunctional piece of equipment which can obtain images of the surface structure and morphology of the material with a resolution of several nm and a very large depth of field; it also gives quality (BSE) chemical information and quantitative chemical information (EDXS, lateral resolution approximately 1 m).

EDXS is a technique in which X-rays generated by the interaction between the electron beam and the sample are analysed to give an elementary composition of the sample. An EDXS spectrum includes peaks which correspond to the characteristic radiations of a specific element. A quantitative chemical characterisation of the sample is deduced from the EDXS spectrum.

The SEM-EDXS analysis technique can couple a topographic surface analysis with a scanning electron microscope (SEM) with a chemical analysis using energy-dispersive X-ray spectroscopy (EDXS).

The principle of the SEM is based on the detection of secondary electrons. A beam of electrons (called primary electron) comes into contact with the surface of the sample. At the time of impact with the atoms present at the surface, the primary electrons can give up energy to electrons in the outer shells of these atoms. These electrons are then ejected and referred to as secondary electrons. The analysis of these electrons, which come from the surface layers, provides information on the topography. When the primary electrons collide with the atoms, these atoms can enter an excited state. On returning to a stable state, they emit X-rays for which the wavelength is characteristic of the nature of the atom. Thus, analysis of these X-rays provides information on the chemical nature of the sample.

Physicochemical analysis by SEM-EDXS analysis of the surface also shows a macroporosity of this PEEK or PEEK/SiC sublayer.

A layer is obtained with a very high porosity due to the accumulation of partially melted PEEK particles.

The silicone coating spread by spraying can be impregnated into the macroporosity of the sublayer; after cross-linking of the silicone resin, this creates a composite, without the need for post-treatment (hot pressing, etc.).

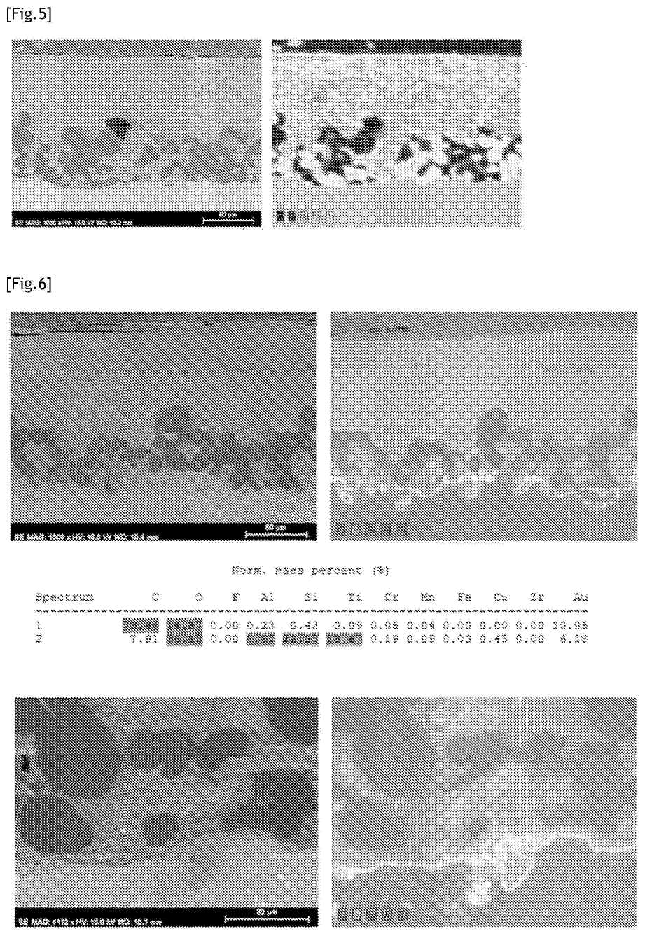

The silicone becomes inter-penetrated with the macromolecular chains of PEEK, optionally in the presence of silicon carbide fillers, which creates a dense network having excellent mechanical properties due to the anchoring of the silicone in the porous PEEK or PEEK/SiC network (FIG. 5).

### Porosity Evaluation Tests by X-Ray Microtomography Analysis.

X-ray microtomography is a powerful non-destructive inspection technique which can generate a magnified image of a sample in 3D. Its operation is based on the same physical principles as the medical scanner, and can achieve a better spatial resolution, less than a micrometre. This technique consists of acquiring a large number of radiographic projections of a sample from multiple angles in order to digitally reconstruct a 3D map of the phases which make up the sample.

X-ray radiography consists of passing a beam of X-rays through a sample, and measuring the spatial distribution of the intensity of the beam exiting the sample, on a detector.

Various X-ray sources can be used in X-ray microtomography, in particular X-ray tubes and synchrotrons. These two types of sources have different characteristics, which influence the microtomography acquisitions.

For our analyses, the source used was a synchrotron, which, unlike X-ray tubes, emits a parallel beam of X-rays. The magnification of the radiographic projections is performed by the detector. This incorporates an optical system which can be adjusted to select the desired size of pixel. Thus, it is not necessary to bring the sample and the source close together in order to improve the acquisition resolution, which makes it possible to overcome limitations on the size of objects, and gives access to pixel sizes less than 1 μm.

The X-rays used in radiography are sufficiently energetic to pass through the majority of materials; they are only slightly absorbed by the lighter elements and can pass through large thicknesses of matter. When an X-ray beam passes through a sample, it is affected by various physical mechanisms which are manifest by a reduction in its intensity until it exits from the sample. This attenuation is proportional to the thickness and to the coefficient of attenuation of the phases passed through. Thus, each unit sensor of the detector measures an intensity which depends on the path of the matter passed through by the beam. These local intensity measurements are then digitised and converted to form a greyscale image, referred to as a radiograph or radiographic projection.

Radiographic systems can also generate a magnification of the projected image, through the geometry of the beam emitted by the X-ray source or via the detection system.

The regions of low density correspond to low greyscale (almost black) where high-density regions correspond to high greyscale (almost white). These contrasts in greyscale make it possible to distinguish the phases of different densities.

The distribution of greyscale in the microtomography data can be visualised on a histogram. The greyscale histogram provides information, in particular, on the volume fractions of the various phases of the sample.

### Scratch Resistance Test (Scratch Test):

Using a Rockwell diamond tip with radius 200 μm, a load is progressively applied on the coating, increasing the applied force from 0 to 20 Newtons. The trace of the scratch is then observed by optical microscopy. The value of delamination recorded for the coating corresponds to the force at which a clear crack is observed in the film down to the metal. The parameters for speed increase of the load and movement speed of the tip are kept constant for all the tests.

For each sample, 5 scratches are made, and the mean of the 5 delamination values at the metal are recorded.

### Example 1: Porous PEEK Sublayer+Silicone, on Aluminium

### Procedure:

Raw materials

PEEK (Polyetheretherketone) is manufactured and sold under the brand name VICTREX VICOTE PEEK@703, with diameter D50 25 μm, a glass transition temperature of 143 °C and a melting temperature of 343 °C.
Equipment: Flame spray torch, Eutectic-Castodyn Castodyn DS8000 with a reference flame nozzle Eutectic-Castodyn module SSMA40.
The speed of movement of the torch is 150 to 200 mm/s
Dual powder feeder, Sulzer Metco, and flow of the powder mixture: varies from 2 to 7 g/min
Thickness of the sublayer: between 10 and 50 μm
Propellant gas: compressed air
Fuel gas: acetylene, varies from 10 to 16 l/min and acetylene pressure varies from 0.5 bar to 1 bar
Fuel gas: oxygen varies from 10 to 20.0 l/min and oxygen pressure varies from 3 to 5 bar
The temperature of the support during the application of the hard base: greater than or equal to ambient temperature (of order 20 to 250 °C)
Torch-to-workpiece application distance, between 10 and 20 cm
Workpiece speed of rotation, between 400 and 800 rpm

The thermal spraying method by flame spray or thermal spraying with a flame, is a method for manufacturing a culinary item, characterised in that it comprises the following steps:
a) a step of supplying a metal support in the form of a disc, comprising two opposite faces;
b) a step of shaping said support in order to give it the shape of a calotte, which comprises a bottom and a side wall extending from the bottom, and thus defining a concave internal face suitable for receiving foods and a convex external face;
c) optionally, a step of treating the internal face of the support, in order to obtain a treated face promoting the adherence of a hard base on the support;
d) a step of producing an adherent hard base on said internal face of the support;
e) a step of producing a coating on said hard base formed in step d);
said method being characterised in that step d) of producing the hard base comprises a thermal spraying, on said internal face, of a ceramic and/or polymer material in powdered form, so as to form on said internal face of the calotte, a layer which is at least discontinuous, the discontinuous part being in the form of a partially melted and crystallised surface dispersion, substantially distributed uniformly on said inner internal face, and in that step b) of shaping the support is carried out either before step d) of producing the hard base, or after step e) of producing the ceramic coating.

The silicone coating consisting of layers (3b), (3b′) and (3c) is applied on the macroporous sublayer (3a) as described below

Finally, the composite PEEK/silicone coating is cured at 250 °C for 45 minutes.

### Example 2: Porous PEEK Polymer Sublayer Containing Silicon Carbide, Silicone, on Aluminium

### Procedure:

Raw materials

PEEK (Polyetheretherketone) is manufactured and sold under the brand name VICTREX VICOTE PEEK@703, with diameter D50 25 μm, a glass transition temperature of 143 °C and a melting temperature of 343 °C.

Silicon carbide (brand-name SIKA ABR I F500), diameter D50=12.8 μm
Equipment: Flame spray torch, Eutectic-Castodyn Castodyn DS8000 with a reference flame nozzle Eutectic-Castodyn module SSMA40.
The speed of movement of the torch is 150 to 200 mm/s
Dual powder feeder, Sulzer Metco, and flow of the powder mixture: varies from 2 to 7 g/min
Thickness of the sublayer: between 10 and 50 μm
Propellant gas: compressed air
Fuel gas: acetylene, varies from 10 to 16 l/min and acetylene pressure varies from 0.5 bar to 1 bar
Fuel gas: oxygen varies from 10 to 20.0 l/min and oxygen pressure varies from 3 to 5 bar
The temperature of the support during the application of the hard base: greater than or equal to ambient temperature (of order 20 to 250 °C)
Torch-to-workpiece application distance, between 10 and 20 cm
Workpiece speed of rotation, between 400 and 800 rpm

PEEK/SiC proportion is 70/30.

The silicone coating consisting of layers (3b), (3b′) and (3c) is then prepared and applied in the same way as for example 1.

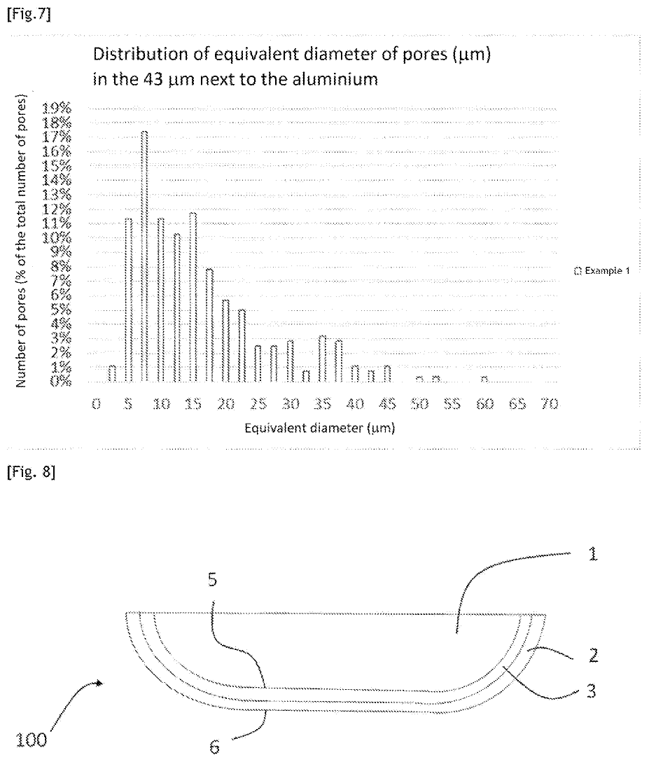

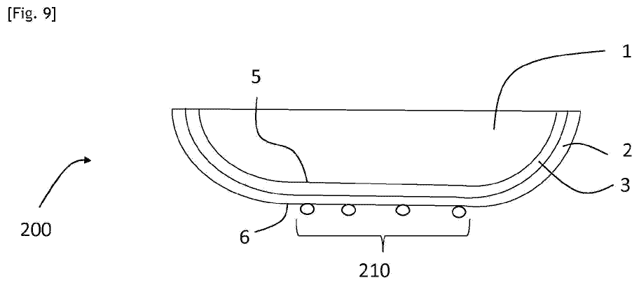

FIG. 7:

The means size of the equivalent diameters of the pores of the hard sublayer is 14.9 μm (measurement by X-ray microtomography within 43 μm from the metal surface).

### Example 3: Porous PEEK Polymer Sublayer Containing Silicon Carbide/Cold Spray Method

The cold spray method enables thick homogeneous solid deposits to be obtained at the surface of substrate to be coated. The principle of cold spray resides in the high-speed spraying of powder particles, which, on colliding with the substrate, will physically deformed. A pressurised flow of gas (0.1 to 5 MPa) is heated (from 25 °C to 1000 °C) then injected into a Laval-type convergent-divergent tube. In this type of tube, called a nozzle, the gas is accelerated until reaching supersonic speeds. The powder is injected into the gas flow upstream or downstream of the nozzle. The gas flow carries the powder particles at high speed to the substrate. If their kinetic energy is sufficient, the particles, as well as the substrate, will deform on impact. Under the deformation, the particles will adhere to the substrate by means of mechanical bonds, and depending on their nature, by chemical or metallurgical bonds. Subsequent particles will be stacked on the preceding layers, thus forming a more or less thick deposit. The sprayed particles remain in the solid state.

### Apparatus Description of the Spray Device:

The cold spray used is a CGT kinetics 3000 coupled with a PF4000 powdered distributor. The pressure range is from 1 to 3 MPa and the temperature range from 300 to 500 °C.

The gas used is nitrogen. The sprays are carried out with a tungsten carbide “MOC24” nozzle, with a diameter <1 mm, attached perpendicularly to the samples and held at 80 mm from the substrates. An illumination speed of 300 mm·s-1 with a servicing step of 1 mm.

An aluminium calotte of thickness 45/10^{th}, is degreased then shot peened or sandblasted before undergoing a surface treatment suitable for removing organic contaminants. The roughness has an Ra of order 5 μm, the surface state has been described above. This disc is preheated to a maximum temperature of 260 °C and used to apply a mixture of powders of PEEK and silicon carbide in a 70/30 mass ratio, by a cold spray method (dynamic spraying by cold gas).

The PEEK (Polyetheretherketone) is manufactured and sold under the brand name VICTREX VICOTE PEEK® 703 with volume-based diameter D50=25 μm.

The thermal method by cold spray is used to obtain a discontinuous deposit of the above powder and in order to deposit a thickness of this layer order 50 μm.

The silicone coating consisting of layers (3b), (3b′) and (3c) is then prepared and applied in the same way as for example 1.

After a single curing at 250 °C for 30 minutes, the coating has a surface that is slightly rough to the touch but does not crack.

Obtaining Layers (3b), (3b′) and (3c):

### Intermediate Layer (3b)

Then a continuous layer (3b) is deposited by spraying on one of the layers (3a) of examples 1, 2 and 3, this continuous layer being chosen from the layer compositions as described below: layer 3b1, layer 3b2 and layer 3b3:

| | | | % in solid |
|---|---|---|---|
| | | | phase, after |
| Component of layer 3b1 | role | % liquid | curing |
| Silicone resin: | binder | 30 | 59.6 |
| RS1 or RS2 or RS3 or RS4 or RS5 | | | |
| or RS6 | | | |
| Dipropylene glycol butyl ether | solvent | 3 | 0 |
| Fatty acid ester | | 3 | 0.5 |
| Cr/Fe oxide | pigment | 10 | 33.1 |
| Deionised water | solvent | 41.40 | 0 |
| Fatty alcohol polyglycol ether | | 4.60 | 0.6 |
| Mineral oil | anti- | 2 | 0.7 |
| | foaming | | |
| | agent | | |
| Silica | | 5 | 5 |
| 2-amino-2-methyl-1-propanol | | 0.5 | 0 |
| Acrylic polymer | thickener | 0.5 | 0.5 |
| TOTAL | | 100 | 100 |

| | | | % in solid |
|---|---|---|---|
| | | | phase, after |
| Component of layer 3b2 | role | % liquid | curing |
| Silicone resin: | binder | 30 | 44.8 |
| RS1 or RS2 or RS3 or RS4 or RS5 | | | |
| or RS6 | | | |
| Thermoplastic polymers: | binder | 10 | 24.9 |
| PES or PAI or PEEK | | | |
| Dipropylene glycol butyl ether | solvent | 3 | 0 |
| Fatty acid ester | | 3 | 0.4 |
| Cr/Fe oxide | pigment | 10 | 24.9 |
| Deionised water | solvent | 31.40 | 0 |
| Fatty alcohol polyglycol ether | | 4.60 | 0.5 |
| Mineral oil | anti- | 2 | 0.5 |
| | foaming | | |
| | agent | | |
| Silica | | 5 | 3.7 |
| 2-amino-2-methyl-1-propanol | | 0.5 | 1.14 |
| Acrylic polymer | thickener | 0.5 | 0.4 |
| TOTAL | | 100 | 100 |

| | | | % in solid |
|---|---|---|---|
| | | | phase, after |
| Component of layer 3b3 | role | % liquid | curing |
| Silicone resin RS2 | binder | 62 | 78.81 |
| 2-methoxy-1- | solvent | 8 | 0 |
| methylethyl acetate | | | |
| Cr/Fe oxide | pigment | 10 | 21.19 |
| Butyl glycol acetate | solvent | 1 | 0 |
| Butyl acetate | solvent | 19 | 0 |
| TOTAL | | 100 | 100 |

The aqueous composition of the layer 3b is prepared according to the ball milling principle. The ball milling is carried out in a jar as described above. The sample can be ground in dry form or dispersed in an appropriate solvent (for example in water or alcohol or in a solvent). The dispersion can also contain certain adjuvants (such as a dispersant or an anti-foaming agent).

The thickness of this layer 3b is from 10 μm to 20 μm, preferably 12 μm to 15 μm.

Intermediate layer (3b′) and finishing layer (3c)

The substrate, on which the layer 3a and the continuous layer 3b is applied, as described above, is coated with a multilayer non-stick coating composed of an intermediate layer 3b (6-8 μm) which is dried for 4 minutes at 100 °C and a finishing layer 3c (14-18 μm). The assembly being finally heated to 250 °C for 30 minutes to 1 hour, i.e. the method comprises only one curing step, after the deposit of the various layers.

The compositions of the intermediate layers 3b′ are deposited by spraying and are as described below: layer 3b′ and layer 3b′2:

| | | | % in solid |
|---|---|---|---|
| Component of | | | phase, after |
| intermediate layer 3b′1 | role | % liquid | curing |
| Silicone resin: | binder | 30 | 73.5 |
| RS1 or RS2 or RS3 or | | | |
| RS4 or RS5 or RS6 | | | |
| Dipropylene glycol | solvent | 3 | 0 |
| butyl ether | | | |
| Fatty acid ester | wetting agent | 3 | 0.6 |
| Mica | flakes | 3 | 12.3 |
| Cr/Fe oxide | pigment | 1 | 4.1 |
| Deionised water | solvent | 46.40 | 0 |
| Fatty alcohol | emulsifying agent | 4.60 | 0.8 |
| polyglycol ether | | | |
| Mineral oil | anti-foaming agent | 2 | 0.8 |
| Silica | | 5 | 6.1 |
| 2-amino-2-methyl- | | 0.5 | 0 |
| 1-propanol | | | |
| Acrylic polymer | thickener | 1.5 | 1.8 |
| TOTAL | | 100 | 100 |

| | | | % in solid |
|---|---|---|---|
| Component of | | | phase, after |
| intermediate layer 3b′2 | role | % liquid | curing |
| Silicone resin: | binder | 30 | 80 |
| RS1 or RS2 or RS3 or | | | |
| RS4 or RS5 or RS6 | | | |
| Dipropylene glycol | solvent | 5 | 0 |
| butyl ether | | | |
| Propoxylated | wetting agent | 1 | 0.1 |
| polyglycol ether | | | |
| Perylene red | pigment | 3 | 13.3 |
| Carbon black | pigment | 2 | 2.9 |
| Deionised water | solvent | 52 | 0 |
| Fatty acid | emulsifying agent | 2 | 0.4 |
| polyglycol ether | | | |
| Mineral oil | anti-foaming agent | 3 | 1.3 |
| 2-amino-2-methyl- | buffer agent | 0.5 | 0 |
| 1-propanol | | | |
| Acrylic polymer | thickener | 1.5 | 2 |
| TOTAL | | 100 | 100 |

| | | | % in solid |
|---|---|---|---|
| Component of | | | phase, after |
| intermediate layer 3b′3 | role | % liquid | curing |
| Silicone resin: | binder | 30 | 75.4 |
| RS1 or RS2 or RS3 or | | | |
| RS4 or RS5 or RS6 | | | |
| Dipropylene glycol | solvent | 5 | 0 |
| butyl ether | | | |
| Propoxylated | wetting agent | 1 | 0.1 |
| polyglycol ether | | | |
| Iron (III) oxide | pigment | 5 | 21.0 |
| Deionised water | solvent | 52 | 0 |
| Fatty alcohol | emulsifying agent | 2 | 0.3 |
| polyglycol ether | | | |
| Mineral oil | anti-foaming agent | 3 | 1.3 |
| 2-amino-2-methyl- | buffer agent | 0.5 | 0 |
| 1-propanol | | | |
| Acrylic polymer | thickener | 1.5 | 1.9 |
| TOTAL | | 100 | 100 |

The compositions of the finishing layers 3c are deposited by spraying and are as described below: layers 3c1 to layer 3c10:

| | | | % in solid |
|---|---|---|---|
| Finishing layer | | | phase, after |
| component 3c1 | role | % liquid | curing |
| Silicone resin RS1 | binder | 35 | 95.5 |
| Dipropylene glycol | solvent | 6 | 0 |
| butyl ether | | | |
| Propoxylated | | 2 | 0.3 |
| polyglycol ether | | | |
| Mineral oil | anti-foaming agent | 1 | 0.5 |
| Mica | pigment | 0.5 | 2.3 |
| Deionised water | solvent | 50.5 | 0 |
| Fatty alcohol | emulsifying agent | 4 | 0.7 |
| polyglycol ether | | | |
| 2-amino-2-methyl- | buffer agent | 0.5 | 0 |
| 1-propanol | | | |
| Acrylic polymer | thickener | 0.5 | 0.7 |
| TOTAL | | 100 | 100 |

| | | | % in solid |
|---|---|---|---|
| Finishing layer | | | phase, after |
| component 3c2 | role | % liquid | curing |
| Silicone resin RS1 | binder | 35 | 91.5 |
| Dipropylene glycol | solvent | 6 | 0 |
| butyl ether | | | |
| Anionic ester in | wetting agent | 1 | 0.1 |
| ethanol/water | | | |
| Mineral oil | anti-foaming agent | 1 | 0.4 |
| Polyether modified | oil | 0.5 | 2.2 |
| polysiloxane | | | |
| Polydimethylsiloxane oil | oil | 1 | 4.4 |
| Deionised water | solvent | 50.50 | 0 |
| Fatty acid | emulsifying agent | 4 | 0.7 |
| polyglycol ether | | | |
| 2-amino-2-methyl- | buffer agent | 0.5 | 0 |
| 1-propanol | | | |
| Acrylic polymer | thickener | 0.5 | 0.7 |
| TOTAL | | 100 | 100 |

| | | | % in solid |
|---|---|---|---|
| Finishing layer | | | phase, after |
| component 3c3 | role | % liquid | curing |
| Silicone resin RS1 | binder | 67 | 100 |
| 2-methoxy-1-methylethyl acetate | solvent | 33 | 0 |

| | | | % in solid |
|---|---|---|---|
| Finishing layer | | | phase, after |
| component 3c4 | role | % liquid | curing |
| Silicone resin RS4 | binder | 69 | 100 |
| 2-methoxy-1-methylethyl acetate | solvent | 31 | 0 |

| | | | % in solid |
|---|---|---|---|
| Finishing layer | | | phase, after |
| component 3c5 | role | % liquid | curing |
| Silicone resin RS4 | binder | 80 | 100 |
| 2-methoxy-1-methylethyl acetate | solvent | 20 | 0 |

| | | | % in solid |
|---|---|---|---|
| Finishing layer | | | phase, after |
| component 3c6 | role | % liquid | curing |
| Silicone resin RS1 | binder | 75 | 87.38 |
| 2-methoxy-1- | solvent | 8 | 0 |
| methylethyl acetate | | | |
| Methyl phenyl | flow agent | 0.5 | 0.97 |
| polysiloxane | | | |
| Carbon black | pigment | 5 | 9.71 |
| Fumed silica after- | filler | 1 | 1.94 |
| treated with dimethyl | | | |
| dichlorosilane | | | |
| Butyl glycol acetate | solvent | 1 | 0 |
| Butyl acetate | solvent | 9.5 | 0 |
| TOTAL | | 100 | 100 |

| | | | % in solid |
|---|---|---|---|
| Finishing layer | | | phase, after |
| component 3c7 | role | % liquid | curing |
| Silicone resin RS1 | binder | 75 | 94.74 |
| 2-methoxy-1- | solvent | 8 | 0 |
| methylethyl acetate | | | |
| Fumed silica after- | filler | 2 | 4.21 |
| treated with dimethyl | | | |
| dichlorosilane | | | |
| Mica | pigment | 0.5 | 1.05 |
| Butyl glycol acetate | solvent | 1 | 0 |
| Butyl acetate | solvent | 13.5 | 0 |
| TOTAL | | 100 | 100 |

| | | | % in solid |
|---|---|---|---|
| Finishing layer | | | phase, after |
| component 3c8 | role | % liquid | curing |
| Silicone resin RS6 | binder | 30 | 74.26 |
| Fumed silica after- | filler | 2 | 8.25 |
| treated with dimethyl | | | |
| dichlorosilane | | | |
| Dipropylene glycol | solvent | 4.5 | 0 |
| butyl ether | | | |
| Fatty acid ester | | 3 | 5.94 |
| Mica | pigment | 0.5 | 2.06 |
| Deionised water | solvent | 51.6 | 0 |
| Fatty alcohol | emulsifying agent | 5.5 | 4.99 |
| polyglycol ether | | | |
| Mineral oil | anti-foaming agent | 1.9 | 4 |
| 2-amino-2-methyl- | buffer agent | 0.5 | 0 |
| 1-propanol | | | |
| Acrylic polymer | thickener | 0.5 | 0.5 |
| TOTAL | | 100 | 100 |

| | | | % in solid |
|---|---|---|---|
| Finishing layer | | | phase, after |
| component 3c9 | role | % liquid | curing |
| Silicone resin RS2 | binder | 70 | 94.74 |
| 2-methoxy-1- | solvent | 8 | 0 |
| methylethyl acetate | | | |
| Fumed silica after- | filler | 2 | 4.21 |
| treated with dimethyl | | | |
| dichlorosilane | | | |
| Mica | pigment | 0.5 | 1.05 |
| Butyl glycol acetate | solvent | 1 | 0 |
| Butyl acetate | solvent | 13.5 | 0 |
| TOTAL | | 100 | 100 |

| | | | % in solid |
|---|---|---|---|
| Finishing layer | | | phase, after |
| component 3c10 | role | % liquid | curing |
| Silicone resin RS1 | binder | 60 | 92.78 |
| 2-methoxy-1- | solvent | 8 | 0 |
| methylethyl acetate | | | |
| Fumed silica after- | filler | 2 | 4.21 |
| treated with dimethyl | | | |
| dichlorosilane | | | |
| Mica | pigment | 0.5 | 1.05 |
| Butyl glycol acetate | solvent | 1 | 0 |
| Polydimethylsiloxane oil | oil | 1 | 2.06 |
| Butyl acetate | solvent | 19.7 | 0 |
| TOTAL | | 100 | 100 |

### Comparative Example: Silicone, without PEEK Sublayer, on Aluminium

In this comparative example, there is no polymer sublayer applied on the sand-blasted aluminium substrate, instead the same silicone layers as examples 1 and 2 are applied directly.

The methods of formulation, coating and final curing are also unchanged with respect to example 1.

### Test Results and Sem/EDXS Characterisation

### Mechanical Impact Resistance Test

The results are described below:

| | | Resistance to | |
|---|---|---|---|
| | | the impact | |
| | | Internal | External |
| Example | Coating configuration | stamping/5 | stamping/5 |
| 1 | PEEK/silicone | 4/5 | 4/5 |
| 2 | PEEK SiC/silicone | 4/5 | 4/5 |
| Comparative | silicone | 2/5 | 2/5 |

### Method for Evaluating the Properties of the Non-Stick Coating: EGG TEST PERFORMANCE

The method for evaluating the non-stick coating properties is carried out based on the egg test adapted from standard AFNOR NF D 21-511 paragraph 3.3.2, and implemented in the following manner:

The sample is cleaned, then the water remaining on the surface is wiped off.

The internal surface of the vessel body is dried beforehand.

The cooking vessel is heated on a gas hob to a temperature between 140 and 170 °C.

A size 60/65 egg is broken and then poured into the centre of the hot cooking vessel.

There is then a wait until the egg has coagulated (6 to 9 minutes). The egg is removed from the cooking vessel with the help of a spatula, the coating is cleaned using a damp vegetable sponge and, through this action, the non-stick properties of the cooking vessel are evaluated. A record is then made of:
Score 100: the egg is entirely removed using a plastic spatula;
Score 75: the egg is not entirely removed but the coating is easily cleaned with a damp sponge,
Score 50: the egg is not entirely removed but the coating can be cleaned with a damp sponge,
Score 25: the egg is not entirely removed and the coating is not cleaned with a damp sponge.
Score 0: the egg is not removed and the coating cannot be cleaned with a damp sponge.

| | Designs/architectures of cooking elements | | | | | | | | | |
|---|---|---|---|---|---|---|---|---|---|---|
| | according to the invention | | | | | | | | | |
| Base layer (3a) | According to example 1, 2 or 3 | | | | | | | | | |
| Intermediate layer | 3b1 or 3b2 or 3b3 | | | | | | | | | |
| (3b) | | | | | | | | | | |
| Intermediate layer | 3b'1 or 3b'2 or 3b'3 | | | | | | | | | |
| (3b') | | | | | | | | | | |
| Finishing layer (3c) | 3c1 | 3c2 | 3c3 | 3c4 | 3c5 | 3c6 | 3c7 | 3c8 | 3c9 | 3c10 |
| Scores obtained in | 50 | 50 | 50 | 50 | 50 | 50 | 50 | 50 | 50 | 50 |
| the egg test | | | | | | | | | | |

Similar results are obtained in the absence of a base layer (3a) according to the comparative example.

All of the silicone-polyester resin-based coatings according to the invention exhibit good non-stick properties while being adherent to the metal.

1-29. (canceled)

30. A coated cooking element for a culinary item or electrical cooking appliance, comprising a metal substrate coated on at least one face with at least the following layers, in this order starting from the metal substrate:
a porous hard sublayer consisting of one or more polyetherarylketones (PEAK) and the mixtures thereof, optionally fillers, optionally less than 3% by weight of additives relative to the weight of said hard sublayer and optionally less than 3% by weight of colouring agent(s) relative to the weight of said hard sublayer,
optionally one or more intermediate layers consisting of one or more colouring agents and optionally
one or more silicone resins, and/or
one or more thermoplastic polymers and/or,
one or more fillers, and/or
one or more additives
a finishing layer consisting of one or more silicone resins and optionally
one or more thermoplastic polymers, and/or
one or more fillers, and/or
one or more additives, and/or
flakes.

31. The coated cooking element according to claim 30, wherein the mean equivalent diameter of the pores in the hard sublayer is greater than 5 μm.

32. The coated cooking element according to claim 31, wherein the mean equivalent diameter of the pores of the hard sublayer is greater than 8 μm.

33. The coated cooking element according to claim 32, wherein the mean equivalent diameter of the pores of the hard sublayer is greater than 10 μm.

34. The coated cooking element according to claim 30, wherein the median equivalent diameter of the pores of the hard sublayer is greater than 6 μm.

35. The coated cooking element according to claim 34, wherein the median equivalent diameter of the pores of the hard sublayer is greater than 7 μm.

36. The coated cooking element according to claim 30, wherein the hard sublayer displays pores that have an equivalent diameter greater than 30 μm.

37. The coated cooking element according to claim 36, wherein at least 1% of the pores by number in the hard sublayer have an equivalent diameter of the pores greater than 30 μm

38. The coated cooking element according to claim 30, wherein the mean thickness of the hard sublayer is greater than 5 μm.

39. The coated cooking element according to claim 30, wherein the one or more polyetherarylketones represent more than 50% by weight of the hard sublayer.

40. The coated cooking element according to claim 39, wherein the one or more polyetherarylketones represent more than 70% by weight of the hard sublayer.

41. The coated cooking element according to claim 39, wherein the one or more polyetherarylketones represent more than 97% by weight of the hard sublayer, the remainder being optionally completed up to 100% by additives.

42. The coated cooking element according to claim 30, wherein the fillers represent more than 20% by weight of the hard sublayer.

43. The coated cooking element according to claim 30, wherein the hard sublayer has a surface roughness Ra of between 5 m and 100 m.

44. The coated cooking element according to claim 30, wherein the polyetherarylketone of said hard sublayer is PEEK.

45. The coated cooking element according to claim 30, wherein the one or more silicone resins are selected from the group consisting of methyl silicone and/or phenyl silicone and/or methyl-phenyl-silicone resins, methyl silicone-polyester resin (copolymers), phenyl silicone-polyester resin (copolymers), methyl-phenyl-silicones-polyester resin (copolymers), silicone-alkyd resin (copolymers), modified silicone resin and the mixtures thereof.

46. The coated cooking element according to claim 30, wherein the one or more fillers are selected from the group consisting of ceramic and/or mineral and/or metal and/or hydrophobic silica and/or diamond particle fillers.

47. The coated cooking element according to claim 30, wherein the one or more thermoplastic polymers are selected from the group consisting of polyethersulfone (PES), polyphenylene ether sulfone (PPSU), polyamideimide (PAI), polyimide (PI), poly(phenylene oxide) (PPO), poly(arylene sulfide) (PAS), polyetherimide (PEI), polybenzymidazole (PBI), liquid crystal polymers (LCP), polyphenylene sulfide (PPS), polyaryletherketones (PAEK) including polyether ketone (PEK), polyether ether ketone (PEEK), polyether ketone ketone (PEKK), polyether ether ketone ketone (PEEKK) and polyether ketone ether ketone ketone (PEKEKK) and the mixtures thereof.

48. The coated cooking element according to claim 30, wherein the one or more coloring agents are selected from the group consisting of thermochromic pigments, thermostable pigments, flakes, preferably holographic flakes, and the mixtures thereof.

49. The coated cooking element according to claim 48, wherein the one or more thermochromic pigments are selected from the group consisting of Bi₂O₃, Fe₂O₃, V₂O₅, WO₃, CeO₂, In₂O₃, Y_{1.84}Ca_{0.16}Ti_{1.84}V_{0.16}O_{1.84}, AgI, (Bi₁₋ₓAₓ)(V_{1-y}M_{y})O₄ with
x is equal to 0 or x is between 0.001 and 0.999,
y is equal to 0 or y is between 0.001 and 0.999,
A and M are chosen from the group consisting of nitrogen, phosphorus, an alkali metal, an alkaline earth metal, a transition metal, a poor metal, a metalloid or a lanthanide,
A and M are different from each other.

50. The coated cooking element according to claim 48, wherein the one or more thermostable pigments are selected from the group consisting of:
titanium rutile yellow pigment,
yellow pigment derived from bismuth, for example selected from the stabilised bismuth vanadates (Py₁₈₄)
red pigment, for example selected from perylene red, iron oxide,
bismuth oxyhalide orange pigment (PO₈₅),
bismuth vanadate orange pigment (PO₈₆)
tin titanium zinc orange pigment (PO₈₂)
cerium sulfide orange pigment (PO₇₅; PO₇₈)
chromium antimony titanium rutile orange-yellow pigment (PBr₂₄)
zinc tin rutile orange-yellow pigment (Py₂₁₆)
zinc tin sulfide niobium oxide orange-yellow pigment (Py₂₂₇)
niobium tin double oxide orange-yellow pigment
Co₃(PO4)₂
LiCoPO₄
CoAl₂O₄
Cr₂O₃
TiO₂
black pigment PBk28 (Copper chromite black spinel)
and the mixtures thereof.

51. The coated cooking element according to claim 48, wherein the one or more holographic flakes are a mixture of magnetisable particles and non-magnetisable particles.

52. The coated cooking element according to claim 30, wherein said metal substrate is a substrate made of aluminium, stainless steel, cast iron or aluminium, iron, titanium or copper.

53. The coated cooking element according to claim 30, wherein the proportion of silicone resin in the finishing layer is greater than or equal to 20% by weight relative to the total weight of the finishing layer.

54. The coated cooking element according to claim 30, wherein the finishing layer comprises one or more thermoplastic polymers, the proportion of thermoplastic polymers in the finishing layer being less than 50%.

55. The coated cooking element according to claim 30, wherein the proportion of fillers in the hard sublayer is greater than 20% by weight relative to the total weight of said layer.

56. The coated cooking element according to claim 30, wherein the proportion of fillers the proportion of fillers in the finishing layer is less than 10% by weight relative to the total weight of said layer.

57. A method for manufacturing a coated cooking element according to claim 30, comprising the following steps:
a) a step of supplying a metal support, comprising two opposite faces;
b) optionally, a step of treating the internal face of the support, in order to obtain a treated face promoting the adherence of a hard sublayer on the support;
c) a step of producing an adherent hard sublayer on said internal face by thermal spraying, onto said internal face of a powder or dispersion of one or more polyetherarylketones (PEAK) and the mixtures thereof, optionally fillers, optionally less than 3% by weight of additives and optionally less than 3% by weight of coloring agent(s) relative to the weight of said hard sublayer;
d) optionally drying and/or curing
e) optionally applying the one or more intermediate layers;
f) applying the finishing layer;
g) drying and/or curing.

58. A culinary item comprising a coated cooking element according to claim 30.

59. The culinary item according to claim 58, further comprising a heating face intended to be placed in contact with an external heating source, the heating face being opposite the cooking face intended to be placed in contact with foods during cooking.

60. The culinary item according to claim 58, chosen from the group consisting of a saucepan, frying pan, pans or pots for fondue or raclette, stew pot, wok, sauté pan, crepe maker, grill, plancha grill, cooking pot, casserole, vessel for a cooker or bread-making machine, culinary mould.

61. An electric cooking appliance comprising a coated cooking element and a heat source configured to heat said coated cooking element, wherein said coated cooking element is according to claim 30.

62. The electric cooking appliance according to claim 61, chosen from the group consisting of an electric crêpe maker, electric raclette appliance, electric fondue appliance, electric grill, electric plancha grill, electric cooker, bread-making machine, electric pressure-cooking appliances, waffle makers, rice cookers and jam makers.
